(19) United States
(12) Patent Application Publication
(10) Pub. No.: US 2024/0176627 A1
(43) Pub. Date: May 30, 2024

(54) VOICE MESSAGE INTERACTION DISPLAY

(71) Applicant: Tencent Technology (Shenzhen) Company Limited, Shenzhen (CN)

(72) Inventors: Biying HE, Shenzhen (CN); Yiying LU, Shenzhen (CN)

(73) Assignee: Tencent Technology (Shenzhen) Company Limited, Shenzhen (CN)

(21) Appl. No.: 18/434,768

(22) Filed: Feb. 6, 2024

Related U.S. Application Data
(63) Continuation of application No. PCT/CN2023/088259, filed on Apr. 14, 2023.

(30) Foreign Application Priority Data
Sep. 2, 2022 (CN) 202211070736.7

(51) Int. Cl. G06F 9/451; H04M 3/533

(52) U.S. Cl. CPC G06F 9/451; H04M 3/533

(57) ABSTRACT

An interaction method includes displaying a voice message icon and a corresponding identity icon, and, when playing the voice message, displaying a first tape reel, displaying that a tape segment moves toward the identity icon from the first tape reel. The method further includes displaying that at least one of the first tape reel or the identity icon rotates, and a thickness of the first tape reel gradually decreases with playback of the voice message, and displaying the tape segment connecting the identity icon and the first tape reel. The method further includes, at ending playback, stopping display of the first tape reel, displaying that an end of the tape segment moves from the first tape reel toward the identity icon, and stopping display of the tape segment when the end of the tape segment reaches the identity icon.

### RELATED APPLICATIONS

This application is a continuation of International Application No. PCT/CN2023/088259, filed on Apr. 14, 2023, which claims priority to Chinese Patent Application No. 202211070736.7, filed on Sep. 2, 2022, and entitled “INTERACTION METHOD AND APPARATUS BASED ON VOICE MESSAGE, COMPUTER DEVICE, AND STORAGE MEDIUM.” The entire disclosures of the prior applications are hereby incorporated by reference in their entirety.

### FIELD OF THE TECHNOLOGY

This disclosure relates to the field of computer technologies, including an interaction method and apparatus based on a voice message, a computer device, a storage medium, and a computer program product.

### BACKGROUND OF THE DISCLOSURE

With the development of computer technologies, there are increasingly more types of instant messaging applications whose functions are also diversified. An instant messaging application running on a client has a function of sending messages via voice.

In the related art, when a voice interaction recipient receives a voice message, a message icon of the voice message is displayed in the instant messaging application. The voice interaction recipient can use a finger to tap the message icon to listen. If the message icon is tapped again in a playback process, the voice message stops playing. If the message icon is tapped again, the voice message starts playing from the beginning.

However, with the traditional method, in the process of the voice interaction recipient listening to the voice message, the voice interaction recipient can only estimate the playback progress, and the voice message may be listened to repeatedly, resulting in continuous occupation of resources, leading to a problem of low resource utilization.

### SUMMARY

According to various aspects of this disclosure, an interaction method and apparatus based on a voice message, a computer device, a computer-readable storage medium, and a computer program product are provided.

In an aspect, an interaction method based on a voice message includes displaying a voice message icon and a corresponding identity icon of a sender of the voice message, and, in response to a playback trigger event for the voice message, displaying a first tape reel at the voice message icon, displaying that a tape segment moves toward the identity icon from the first tape reel, and triggering a playback of the voice message. The method further includes, in response to a playback trigger event for the voice message, displaying a first tape reel at the voice message icon, displaying that a tape segment moves toward the identity icon from the first tape reel, and triggering a playback of the voice message. The method further includes, in response to a playback end event for the voice message, stopping display of the first tape reel, displaying that an end of the tape segment moves from the first tape reel toward the identity icon, and stopping display of the tape segment when the end of the tape segment reaches the identity icon.

In an aspect, an interaction apparatus based on a voice message, the apparatus including processing circuitry configured to display a voice message icon and a corresponding identity icon of a sender of the voice message, and, in response to a playback trigger event for the voice message, display a first tape reel at the voice message icon, display that a tape segment moves toward the identity icon from the first tape reel, and trigger a playback of the voice message. The processing circuitry is further configured to, in a playback process of the voice message, display that at least one of the first tape reel or the identity icon rotates, and a thickness of the first tape reel gradually decreases with a playback progress of the voice message, and display the tape segment connecting the identity icon and the first tape reel within at least part of the playback process. The processing circuitry is further configured to, in response to a playback end event for the voice message, stop display of the first tape reel, display that an end of the tape segment moves from the first tape reel toward the identity icon, and stop display of the tape segment when the end of the tape segment reaches the identity icon.

In an aspect, a non-transitory computer-readable storage medium stores computer-readable instructions thereon, which, when executed by processing circuitry, cause the processing circuitry to perform an interaction method including displaying a voice message icon and a corresponding identity icon of a sender of the voice message, and, in response to a playback trigger event for the voice message, displaying a first tape reel at the voice message icon, displaying that a tape segment moves toward the identity icon from the first tape reel, and triggering a playback of the voice message. The method further includes, in response to a playback trigger event for the voice message, displaying a first tape reel at the voice message icon, displaying that a tape segment moves toward the identity icon from the first tape reel, and triggering a playback of the voice message. The method further includes, in response to a playback end event for the voice message, stopping display of the first tape reel, displaying that an end of the tape segment moves from the first tape reel toward the identity icon, and stopping display of the tape segment when the end of the tape segment reaches the identity icon.

### BRIEF DESCRIPTION OF THE DRAWINGS

To describe the technical solutions in the aspects of this disclosure, the following briefly describes the accompanying drawings describing the aspects. The accompanying drawings in the following description show merely the aspects of this disclosure, and a person of ordinary skill in the art may derive other drawings from these accompanying drawings.

FIG. 1 is a diagram of an application environment of an interaction method based on a voice message according to an aspect.

FIG. 2 is a schematic flowchart of an interaction method based on a voice message according to an aspect.

FIG. 3 is a schematic diagram of displaying a message bubble of a voice message and a corresponding identity icon according to an aspect.

FIG. 4 is a schematic diagram of displaying a message bubble of a voice message and a corresponding identity icon according to another aspect.

FIG. 5 is a schematic diagram of responding to a playback trigger event according to an aspect.

FIG. 6 is a schematic diagram of rotation of an identity icon according to an aspect.

FIG. 7 is a schematic diagram of rotation of a first tape reel according to an aspect.

FIG. 8 is a schematic diagram of a playback process of a voice message according to an aspect.

FIG. 9 is a schematic diagram of a playback process of a voice message according to another aspect.

FIG. 10 is a schematic diagram of responding to a playback end event according to an aspect.

FIG. 11 is a schematic diagram of responding to a voice message recording event according to an aspect.

FIG. 12 is a schematic diagram of responding to a voice message recording event according to another aspect.

FIG. 13 is a schematic diagram of a recording bubble gradually decreasing as a recording progress according to an aspect.

FIG. 14 is a schematic diagram of voice message recording according to an aspect.

FIG. 15 is a schematic diagram of an outer contour of a second tape reel gradually expanding toward an outer contour of a recording bubble as a recording progress according to an aspect.

FIG. 16 is a schematic diagram of displaying and canceling display of a voice recording icon according to an aspect.

FIG. 17 is a schematic diagram of a part of a message bubble gradually increasing as a playback progress according to an aspect.

FIG. 18 is a schematic diagram of a voice message playback according to an aspect.

FIG. 19 is a schematic diagram of an outer contour of a first tape reel gradually shrinking toward a center of a message bubble as a playback progress according to an aspect.

FIG. 20 is a schematic diagram of displaying and canceling display of a voice playback icon according to an aspect.

FIG. 21 is a schematic diagram of displaying a digital icon with a changing number according to an aspect.

FIG. 22 is a schematic diagram of responding to a voice positioning event according to an aspect.

FIG. 23 is a schematic diagram of obtaining a progress adjustment position, an initial position, and a center point position according to an aspect.

FIG. 24 is a schematic diagram of determining a quadrant in which a progress adjustment position is located according to an aspect.

FIG. 25 is a schematic diagram of obtaining a relative angle according to an aspect.

FIG. 26 is a schematic diagram of responding to a playback interruption event according to an aspect.

FIG. 27 is a schematic diagram of a voice message recording stage according to an aspect.

FIG. 28 is a schematic diagram of a voice message recording stage according to another aspect.

FIG. 29 is a schematic diagram of a voice message playback stage according to an aspect.

FIG. 30 is a schematic diagram of a voice message playback stage according to another aspect.

FIG. 31 is a schematic diagram of responding to a 2× playback event according to an aspect.

FIG. 32 is a schematic diagram of responding to a playback interruption event according to another aspect.

FIG. 33 is a structural block diagram of an interaction apparatus based on a voice message according to an aspect.

FIG. 34 is a diagram of an internal structure of a computer device according to an aspect.

### DETAILED DESCRIPTION

The technical solutions in the embodiments of this disclosure are described below with reference to the accompanying drawings in the embodiments of this disclosure. The described embodiments are merely some rather than all of the embodiments of this disclosure. All other embodiments obtained by a person of ordinary skill in the art based on the embodiments of this disclosure shall fall within the protection scope of this disclosure.

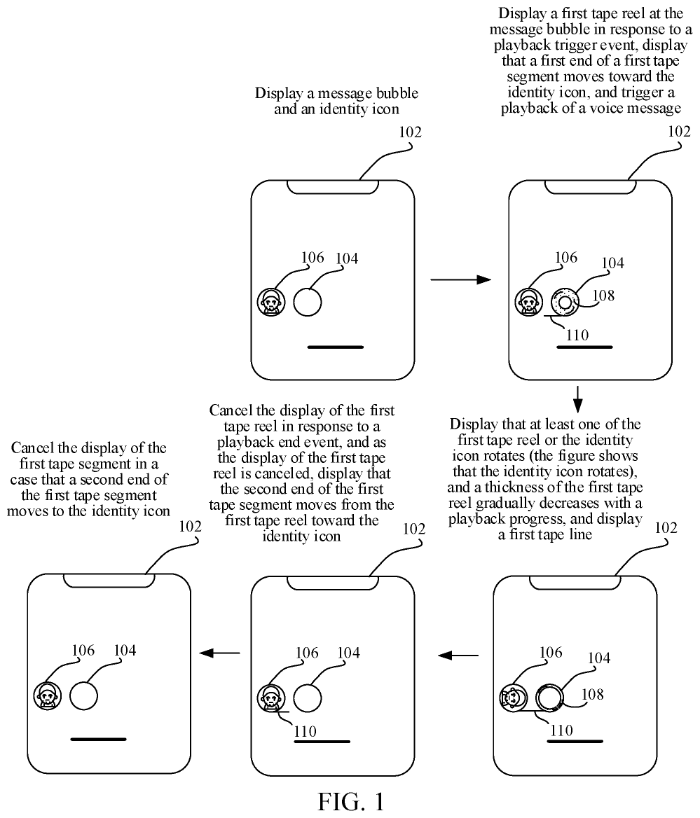

An interaction method based on a voice message provided in the aspects of this disclosure may be applied to an application environment shown in FIG. 1. A client for implementing interaction based on a voice message is installed on a terminal 102. The client may be an instant messaging application, a web client, or a sub-application running in an operating environment of a parent application. The terminal 102 displays a message bubble (or voice message icon) 104 of a voice message and a corresponding identity icon 106. The terminal 102 displays a first tape reel 108 at the message bubble 104 in response to a playback trigger event for the voice message, displays that a second end of a first tape segment 110 is connected to the first tape reel 108, displays that a first end of the first tape segment 110 moves toward the identity icon 106, and triggers a playback of the voice message. In a playback process of the voice message, the terminal 102 displays that at least one of the first tape reel 108 or the identity icon 106 rotates (FIG. 1 shows that the identity icon rotates), and a thickness of the first tape reel 108 gradually decreases with a playback progress of the voice message, and displays the first tape segment 110 connecting the identity icon 106 and the first tape reel 108 within at least part of the time period of the playback process. The terminal 102 cancels the display of the first tape reel 108 in response to a playback end event for the voice message; and as the display of the first tape reel 108 is canceled, displays that the second end of the first tape segment 110 moves from the first tape reel 108 toward the identity icon 106, and cancels the display of the first tape segment 110 when the second end of the first tape segment 110 moves to the identity icon 106. The terminal 102 may be, but not limited to, a desktop computer, a notebook computer, a smartphone, a tablet computer, an Internet of Things device, and a portable wearable device. The Internet of Things device may be a smart speaker, a smart television, a smart air conditioner, a smart in-vehicle device, or the like. The portable wearable device may be a smart watch, a smart band, a head-mounted device, or the like.

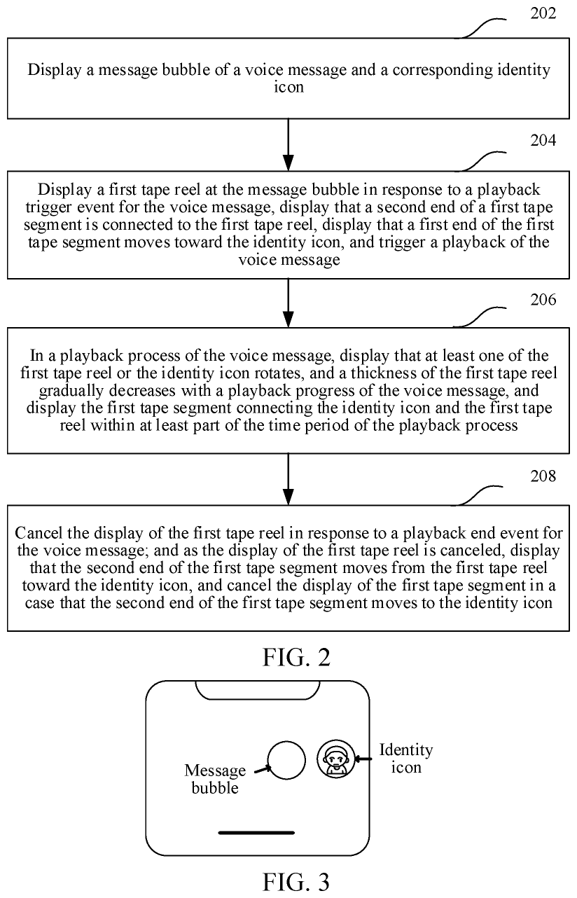

In an aspect, as shown in FIG. 2, an interaction method based on a voice message is provided. An example in which the method is applied to the terminal 102 shown in FIG. 1 is used for description. The method includes the following steps:
Step 202: Display a message bubble of a voice message and a corresponding identity icon. For example, a voice message icon (e.g., message bubble of a voice message) and a corresponding identity icon of the sender of the voice message are displayed.

The message bubble is used for presenting the voice message, which is a special effect for displaying the voice message and is displayed after recording of the voice message ends. The message bubble includes a bubble color and a bubble shape. The bubble color may be configured according to an actual application scenario. In this aspect, the bubble color is not specifically limited. For example, the bubble color may be white or green. Further, an object using the terminal may also pre-configure the bubble color according to its own preference. The bubble shape may be configured according to an actual application scenario. In this aspect, the bubble shape is not specifically limited. For example, the bubble shape may be circular, rectangular, or square. Further, an object using the terminal may also pre-configure the bubble shape according to its own preference. The identity icon refers to an icon of a publishing object of the voice message. For example, the identity icon may specifically refer to a profile photo of the publishing object of the voice message, and the profile photo of the publishing object may be pre-configured by the publishing object according to its own preference.

Specifically, in a process of interaction with a voice interaction object, the terminal displays the message bubble of the voice message and the corresponding identity icon. In a specific application, in the process of interaction with the voice interaction object, to display the voice message, the terminal obtains the pre-configured bubble color and bubble shape, displays the message bubble of the voice message based on the bubble color and the bubble shape, and displays the corresponding identity icon of the voice message.

In a specific application, for a publishing object and a receiving object of the voice message in the voice interaction object, relative positions of the message bubble and the corresponding identity icon of the voice messages displayed by the terminals used may be different. In a specific application, as shown in FIG. 3, for the receiving object of the voice message in the voice interaction object, the message bubble of the voice message displayed by the terminal used is located on the right side of the corresponding identity icon, and a center of the message bubble and a center of the identity icon are on the same horizontal line. In a specific application, as shown in FIG. 4, for the publishing object of the voice message in the voice interaction object, the message bubble of the voice message displayed by the terminal used is located on the left side of the corresponding identity icon, and a center of the message bubble and a center of the identity icon are on the same horizontal line.
Step 204: Display a first tape reel at the message bubble in response to a playback trigger event for the voice message, display that a second end of a first tape segment is connected to the first tape reel, display that a first end of the first tape segment moves toward the identity icon, and trigger a playback of the voice message. For example, in response to a playback trigger event for the voice message, a first tape reel is displayed at the voice message icon, a tape segment that moves toward the identity icon from the first tape reel is displayed, and playback of the voice message is triggered.

The playback trigger event refers to an event that triggers the playback of the voice message. For example, the playback trigger event may specifically refer to a selection operation for the message bubble. For example, the selection operation for the message bubble may specifically refer to one of a tap operation, a tap and hold operation, and a double tap operation. In another example, the playback trigger event may specifically refer to that, when at least two voice messages can be played continuously, a playback of a previous voice message corresponding to the voice message has ended. The first tape reel refers to a virtual animation representing a shape of a tape reel for the playback of the voice message. The shape of the tape reel refers to a shape of a tape winding around a reel similar to a physical tape reel, that is, the tape winds around the reel to form the tape reel.

Specifically, the terminal monitors the playback trigger event for the voice message in real time. When detecting the playback trigger event for the voice message, the terminal displays the first tape reel at the message bubble in response to the playback trigger event for the voice message, displays that the second end of the first tape segment is connected to the first tape reel, and displays that the first end of the first tape segment moves toward the identity icon, and triggers the playback of the voice message. In a specific application, in the playback process of the voice message, the first end of the first tape segment continues to move toward the identity icon as the playback progress, and the terminal displays the first tape segment connecting the identity icon and the first tape reel when the first end of the first tape segment moves to the identity icon.

In a specific application, the terminal displays the first tape reel at the message bubble in response to the playback trigger event for the voice message, displays that the second end of the first tape segment is connected to the first tape reel, displays that the first end of the first tape segment moves toward the identity icon, and triggers the playback of the voice message. In the playback process of the voice message, the first end of the first tape segment continues to move toward the identity icon with the playback progress, and the terminal displays the first tape segment connecting the identity icon and the first tape reel when the first end of the first tape segment moves to the identity icon.

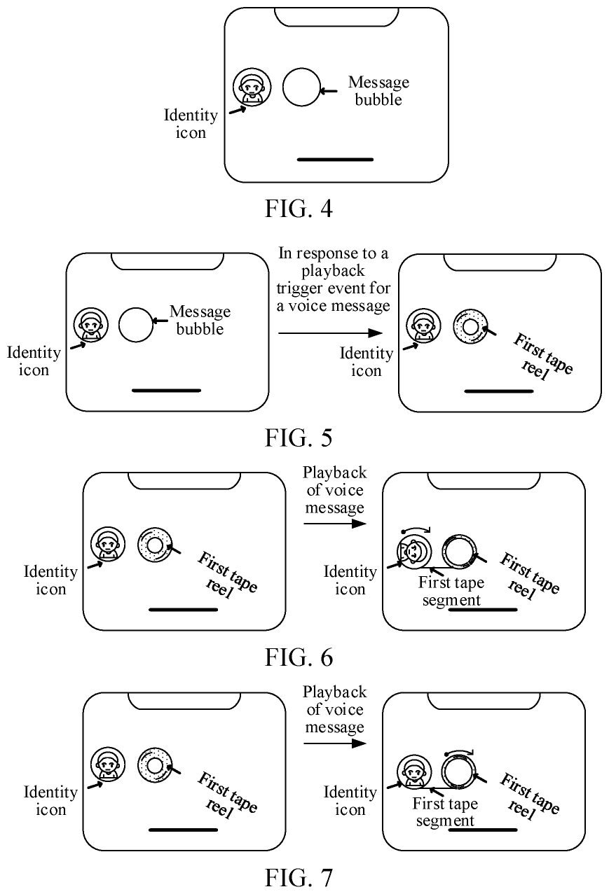

In a specific application, as shown in FIG. 5, the terminal displays the message bubble of the voice message and the corresponding identity icon, and displays the first tape reel representing the playback of the voice message at the message bubble in response to the playback trigger event for the voice message.
Step 206: In a playback process of the voice message, display that at least one of the first tape reel or the identity icon rotates, and a thickness of the first tape reel gradually decreases with a playback progress of the voice message, and display the first tape segment connecting the identity icon and the first tape reel within at least part of the time period of the playback process. For example, a tape segment connecting the identity icon and the first tape reel is displayed within at least a part of the playback process.

The thickness of the first tape reel refers to the thickness of the tape wound on the reel, and is related to a message duration of the voice message. A longer message duration indicates a thicker tape. That the thickness of the first tape reel gradually decreases with the playback progress of the voice message refers to that the thickness of the first tape reel changes with the playback progress of the voice message. As the playback progress increases, the thickness of the first tape reel gradually decreases, that is, as the playback progress increases, the tape wound on the reel of the first tape reel gradually decreases. The first tape segment refers to a tape segment for connecting the identity icon and the first tape reel in the playback process of the voice message. The first tape segment includes a first end and a second end. The first end of the first tape segment is used for connecting to the identity icon, and the second end of the first tape segment is used for connecting to the first tape reel.

Specifically, in the playback process of the voice message, the terminal displays that at least one of the first tape reel or the identity icon rotates, and the thickness of the first tape reel gradually decreases with the playback progress of the voice message, and displays the first tape segment connecting the identity icon and the first tape reel within at least part of the time period of the playback process.

In a specific application, the terminal displays that the identity icon rotates, and the first tape reel does not rotate. A rotation direction of the identity icon may be pre-configured according to an actual application scenario. For example, the rotation direction may be clockwise or counterclockwise. In a specific application, as shown in FIG. 6, in the playback process of the voice message, the terminal displays that the identity icon rotates clockwise and the first tape reel does not rotate, and the thickness of the first tape reel gradually decreases with the playback progress of the voice message, and displays the first tape segment connecting the identity icon and the first tape reel within at least part of the time period of the playback process.

In a specific application, the terminal displays that the identity icon does not rotate, and the first tape reel rotates. A rotation direction of the first tape reel may be pre-configured according to an actual application scenario. For example, the rotation direction may be clockwise or counterclockwise. In a specific application, as shown in FIG. 7, in the playback process of the voice message, the terminal displays that the first tape reel rotates clockwise and the identity icon does not rotate, and the thickness of the first tape reel gradually decreases with the playback progress of the voice message, and displays the first tape segment connecting the identity icon and the first tape reel within at least part of the time period of the playback process.

In a specific application, the terminal displays that the identity icon and the first tape reel rotate at the same time. The rotation directions of the identity icon and the first tape reel may be pre-configured according to an actual application scenario, and may be the same or different. For example, when the identity icon and the first tape reel rotate at the same time, a rotation mode may be that the identity icon rotates clockwise and the first tape reel rotates counterclockwise, or may be that the identity icon rotates counterclockwise and the first tape reel rotates clockwise.

In a specific application, displaying the first tape segment connecting the identity icon and the first tape reel within at least part of the time period of the playback process refers to displaying the first tape segment connecting the identity icon and the first tape reel in the playback process when the first end of the first tape segment moves to the identity icon and the second end of the first tape segment is connected to the first tape reel, and no longer displaying the first tape segment connecting the identity icon and the first tape reel when the second end of the first tape segment moves from the first tape reel toward the identity icon.

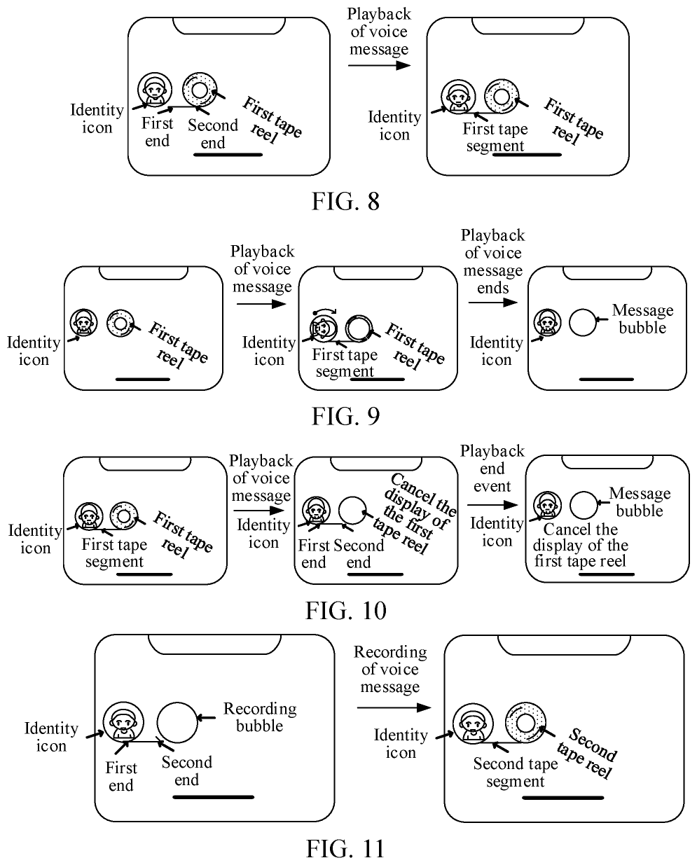

In a specific application, as shown in FIG. 8, in the playback process of the voice message, the terminal first displays that the second end of the first tape segment is connected to the first tape reel, and the first end of the first tape segment moves toward the identity icon. The terminal displays the first tape segment connecting the identity icon and the first tape reel when the first end of the first tape segment moves to the identity icon. In this case, the second end of the first tape segment is connected to the first tape reel, and the first end of the first tape segment is connected to the identity icon.
Step 208: Cancel the display of the first tape reel in response to a playback end event for the voice message; and as the display of the first tape reel is canceled, display that the second end of the first tape segment moves from the first tape reel toward the identity icon, and cancel the display of the first tape segment in a case that the second end of the first tape segment moves to the identity icon. For example, in response to a playback end event for the voice message, display of the first tape reel is stopped, an end of the tape segment is displayed as moving from the first tape reel toward the identity icon, and display of the tape segment is stopped when the end of the tape segment reaches the identity icon.

The playback end event refers to an event that the playback of the voice message has ended. For example, the playback end event may specifically refer to that the voice message has been played completely.

Specifically, in the playback process of the voice message, the thickness of the first tape reel gradually decreases with the playback progress of the voice message. With the playback progress of the voice message, the first tape reel becomes thinner. When the playback of the voice message ends, it represents that the playback progress of the voice message is 100%, and the thickness of the first tape reel also becomes 0. The terminal cancels the display of the first tape reel in response to the playback end event for the voice message.

In a specific application, as shown in FIG. 9, in the playback process of the voice message, with the playback progress of the voice message, the first tape reel becomes thinner. When the playback of the voice message ends, the thickness of the first tape reel becomes 0, and the display of the first tape reel is canceled. In this case, the reel returns to the state before responding to the playback trigger event for the voice message, and the terminal displays the message bubble of the voice message and the corresponding identity icon.

Specifically, the terminal responds to the playback end event for the voice message. As the display of the first tape reel is canceled, the terminal displays that the second end of the first tape segment moves from the first tape reel toward the identity icon, and cancels the display of the first tape segment when the second end of the first tape segment moves to the identity icon. In a specific application, as shown in FIG. 10, before responding to the playback end event for the voice message, the terminal displays the first tape segment connecting the identity icon and the first tape reel. When detecting the playback end event for the voice message, the terminal responds to the playback end event for the voice message. As the first tape reel is canceled, the terminal displays that the second end of the first tape segment moves from the first tape reel toward the identity icon, and cancels the display of the first tape segment when the second end of the first tape segment moves to the identity icon.

In the interaction method based on a voice message, the message bubble of the voice message and the corresponding identity icon are displayed, the first tape reel is displayed at the message bubble in response to the playback trigger event for the voice message, that the second end of the first tape segment is connected to the first tape reel is displayed, that the first end of the first tape segment moves toward the identity icon is displayed, and the playback of the voice message is triggered. In this way, the display form when the playback of the voice message starts can be enriched, so that the voice interaction object can intuitively perceive that the playback of the voice message starts. In the playback process of the voice message, by using the first tape segment to display that the first tape reel rotates together with the identity icon, and by using that the thickness of the first tape reel gradually decreases with the playback progress of the voice message, the change of the playback progress of the voice message can be simulated by using the thickness change during the tape reel rotation, so that the voice interaction object can intuitively perceive the playback progress, and there is no need to listen to the voice message repeatedly. This can reduce a quantity of times of repeated listening to the voice message, avoid continuous occupation of resources, and improve resource utilization. The display of the first tape reel is canceled in response to the playback end event for the voice message, and as the display of the first tape reel is canceled, that the second end of the first tape segment moves from the first tape reel toward the identity icon is displayed, and the display of the first tape segment is canceled when the second end of the first tape segment moves to the identity icon. As the display of the first tape reel is canceled, a playback end state of the voice message can be simulated by using the movement of the second end of the first tape segment, so that the voice interaction object can intuitively perceive the end of the playback of the voice message.

In an aspect, the displaying a message bubble of a voice message and a corresponding identity icon includes:
displaying the identity icon and a second tape reel in response to a voice message recording event, and triggering recording of the voice message;
in a recording process of the voice message, displaying that at least one of the second tape reel or the identity icon rotates, and a thickness of the second tape reel gradually increases with a recording progress of the voice message, and displaying a second tape segment connecting the identity icon and the second tape reel within at least part of the time period of the recording process; and
canceling the display of the second tape reel in response to a voice message recording end event and displaying the message bubble of the voice message.

The voice message recording event refers to an event that triggers the recording of the voice message. For example, the voice message recording event may specifically refer to a selection operation for a recording control. For example, the selection operation for the recording control may specifically refer to one of a tap operation, a tap and hold operation, and a double tap operation.

The second tape reel refers to a virtual animation representing a shape of a tape reel for the recording of the voice message. The shape of the tape reel refers to a shape of a tape winding around a reel similar to a physical tape reel, that is, the tape winds around the reel to form the tape reel. The thickness of the second tape reel refers to the thickness of the tape wound on the reel, and is related to a message duration of the voice message. A longer message duration indicates a thicker tape. That the thickness of the second tape reel gradually increases with the recording progress of the voice message refers to that the thickness of the second tape reel changes with the recording progress of the voice message. As the recording progress increases, the thickness of the second tape reel gradually increases, that is, as the recording progress increases, the tape wound on the reel of the second tape reel gradually increases.

The second tape segment refers to a tape segment for connecting the identity icon and the second tape reel in the recording process of the voice message. The second tape segment includes a first end and a second end. The first end of the second tape segment is used for connecting to the identity icon, and the second end of the second tape segment is used for connecting to the first tape reel.

Specifically, the terminal monitors the voice message recording event in real time. When detecting the voice message recording event, the terminal displays the identity icon and the second tape reel in response to the voice message recording event, and triggers the recording of the voice message. In the recording process of the voice message, the terminal displays that at least one of the second tape reel or the identity icon rotates, and the thickness of the second tape reel gradually increases with the recording progress of the voice message, and displays the second tape segment connecting the identity icon and the second tape reel within at least part of the time period of the recording process. In the recording process of the voice message, the terminal monitors the voice message recording end event in real time. When detecting the voice message recording end event, the terminal cancels the display of the second tape reel in response to the voice message recording end event, and displays the message bubble of the voice message.

In a specific application, in the recording process of the voice message, the terminal displays that the identity icon rotates, and the second tape reel does not rotate. A rotation direction of the identity icon may be pre-configured according to an actual application scenario. For example, the rotation direction may be clockwise or counterclockwise. In a specific application, in the recording process of the voice message, the terminal displays that the identity icon does not rotate, and the second tape reel rotates. A rotation direction of the second tape reel may be pre-configured according to an actual application scenario. For example, the rotation direction may be clockwise or counterclockwise. In a specific application, the terminal displays that the identity icon and the second tape reel rotate at the same time. The rotation directions of the identity icon and the second tape reel may be pre-configured according to an actual application scenario, and may be the same or different. For example, when the identity icon and the second tape reel rotate at the same time, a rotation mode may be that the identity icon rotates clockwise and the second tape reel rotates counterclockwise, or may be that the identity icon rotates counterclockwise and the second tape reel rotates clockwise.

In a specific application, displaying the second tape segment connecting the identity icon and the second tape reel within at least part of the time period of the recording process refers to displaying the second tape segment connecting the identity icon and the second tape reel in the recording process when the second end of the second tape segment moves to the second tape reel and the first end of the second tape segment is connected to the identity icon, and no longer displaying the second tape segment connecting the identity icon and the second tape reel when the first end of the second tape segment moves from the identity icon toward the second tape reel.

In this aspect, the identity icon and the second tape reel are displayed in response to a voice recording event, and the recording of the voice message is triggered, which can enrich the form of voice message recording. In the recording process of the voice message, by using the second tape segment to display that the second tape reel rotates together with the identity icon, and by using that the thickness of the second tape reel gradually increases with the recording progress of the voice message, a recording party of the voice message can be displayed, and the change of the recording progress of the voice message can be simulated by using the thickness change in during the tape reel rotation, so that the voice interaction object can intuitively perceive the recording progress. The recording of the voice message can be completed by canceling the display of the second tape reel in response to the voice message recording end event, thereby displaying the message bubble of the voice message.

In an aspect, the displaying the identity icon and a second tape reel in response to a voice message recording event, and triggering recording of the voice message includes:
displaying the identity icon and a recording bubble in response to the voice message recording event, displaying that a first end of the second tape segment is connected to the identity icon, displaying that a second end of the second tape segment moves from the identity icon toward the recording bubble, and triggering the recording of the voice message; and
displaying the second tape reel at the recording bubble in a case that the second end of the second tape segment is connected to the recording bubble.

The recording bubble is used for presenting that the recording of the voice message starts, which is a special effect for starting the recording of the voice message and is displayed before the recording of the voice message starts. The recording bubble includes a bubble color and a bubble shape. The bubble color may be configured according to an actual application scenario. In this aspect, the bubble color is not specifically limited. For example, the bubble color may be white or green. Further, an object using the terminal may also pre-configure the bubble color according to its own preference. The bubble shape may be configured according to an actual application scenario. In this aspect, the bubble shape is not specifically limited. For example, the bubble shape may be circular, rectangular, or square. Further, an object using the terminal may also pre-configure the bubble shape according to its own preference.

Specifically, the terminal displays the identity icon and the recording bubble in response to the voice message recording event, displays that the first end of the second tape segment is connected to the identity icon, displays that the second end of the second tape segment moves from the identity icon toward the recording bubble, and triggers the recording of the voice message. After the recording of the voice message starts, the second end of the second tape segment continues to move toward the recording bubble. The terminal displays the second tape reel at the recording bubble when the second end of the second tape segment is connected to the recording bubble.

In a specific application, as shown in FIG. 11, the terminal displays the identity icon and the recording bubble in response to the voice message recording event, displays that the first end of the second tape segment is connected to the identity icon, displays that the second end of the second tape segment moves from the identity icon toward the recording bubble, and triggers the recording of the voice message. After the voice message starts to be recorded, the second end of the second tape segment continues to move toward the recording bubble. When the second end of the second tape segment is connected to the recording bubble, the terminal displays the second tape reel at the recording bubble.

In this aspect, displaying the identity icon and the recording bubble in response to the voice message recording event, displaying that the first end of the second tape segment is connected to the identity icon, displaying that the second end of the second tape segment moves from the identity icon toward the recording bubble, and triggering the recording of the voice message can enrich a display form of the voice message when the recording of the voice message starts. Displaying the second tape reel at the recording bubble when the second end of the second tape segment is connected to the recording bubble can simulate a recording start state of the voice message by using the movement of the second end of the second tape segment, so that the voice interaction object can intuitively perceive the start of the recording of the voice message.

In an aspect, the canceling the display of the second tape reel in response to a voice message recording end event, and displaying the message bubble of the voice message includes:
displaying that the first end of the second tape segment moves from the identity icon toward the second tape reel in response to the voice message recording end event; and
canceling the display of the second tape reel in a case that the first end of the second tape segment moves to the second tape reel, and displaying the message bubble of the voice message.

The voice message recording end event refers to an event that triggers the end of the recording of the voice message. For example, the voice message recording end event may be specifically implemented by performing an operation on a recording control. For example, the voice message recording end event may specifically refer to stopping tapping the recording control. In another example, the voice message recording end event may specifically refer to a re-selection operation for the recording control. Further, the re-selection operation for the recording control may specifically refer to one of a tap operation, a tap and hold operation, and a double tap operation.

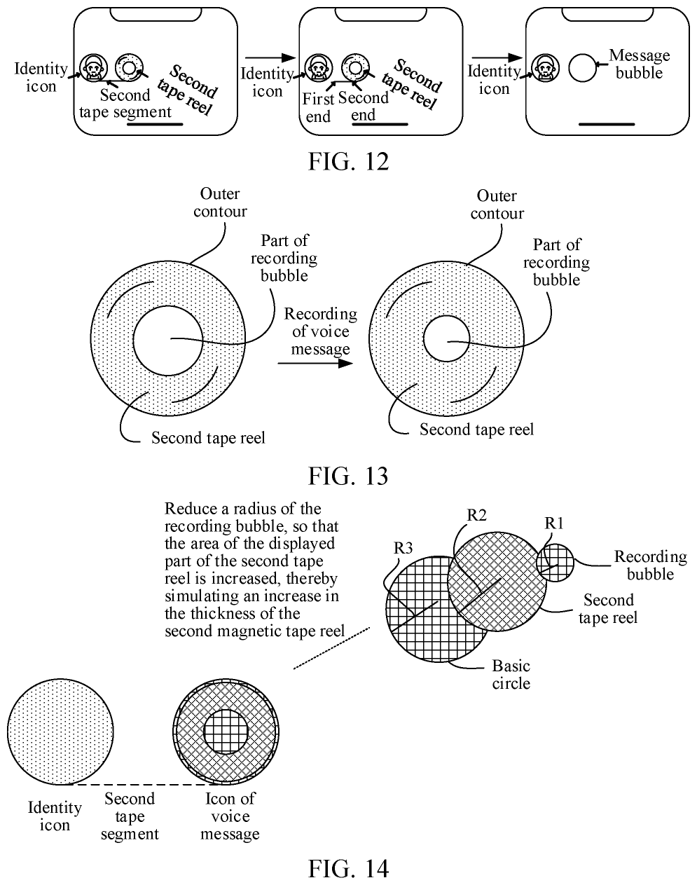

Specifically, the terminal displays that the first end of the second tape segment moves from the identity icon toward the second tape reel in response to the voice message recording end event, and cancels the display of the second tape reel and displays the message bubble of the voice message when the first end of the second tape segment moves to the second tape reel. In a specific application, as shown in FIG. 12, before responding to the voice message recording end event, the terminal displays the second tape segment connecting the identity icon and the second tape reel. When detecting the voice message recording end event, the terminal displays that the first end of the second tape segment moves from the identity icon toward the second tape reel in response to the voice message recording end event, and cancels the display of the second tape reel and displays the message bubble of the voice message when the first end of the second tape segment moves to the second tape reel.

In this aspect, a recording end state of the voice message can be simulated by using the movement of the first end of the second tape segment, so that the voice interaction object can intuitively perceive the end of the recording of the voice message.

In an aspect, in the recording process of the voice message, an outer contour of the second tape reel is consistent with (i.e., coincides with) an outer contour of the recording bubble, a part of the recording bubble is displayed inside the second tape reel, and the part of the displayed recording bubble gradually decreases with the recording progress.

Specifically, as shown in FIG. 13, in the recording process of the voice message, the outer contour of the second tape reel is consistent with the outer contour of the recording bubble, a part of the recording bubble is displayed inside the second tape reel, and the part of the displayed recording bubble gradually decreases with the recording progress, that is, the part of the recording bubble gradually decreases as the recording progress increases.

In this aspect, in the recording process of the voice message, a part of the recording bubble is displayed inside the second tape reel, and the part of the displayed recording bubble gradually decreases with the recording progress. The recording process of the voice message can be simulated by using that the part of the recording bubble gradually decreases with the recording progress, so that the voice interaction object can intuitively perceive that the voice message is being recorded.

In an aspect, both the second tape reel and the recording bubble are in circular shapes, and a center of the second tape reel is consistent with a center of the recording bubble. Before the recording of the voice message starts, the second tape reel is covered by the recording bubble, and the second tape reel is in an invisible state; and in a case that the second end of the second tape segment is connected to the recording bubble, a radius of the recording bubble gradually decreases with the recording progress of the voice message, and the second tape reel is in a visible state.

Specifically, both the second tape reel and the recording bubble are in circular shapes, and the center of the second tape reel is consistent with the center of the recording bubble. Before the recording of the voice message starts, the second tape reel is covered by the recording bubble, and the second tape reel is in the invisible state. That is, in this case, the radius of the second tape reel is equal to the radius of the recording bubble. When the second end of the second tape segment is connected to the recording bubble, it represents that the voice message is being recorded, the radius of the recording bubble gradually decreases with the recording progress of the voice message, and the second tape reel is in the visible state.

In a specific application, both the second tape reel and the recording bubble are in circular shapes, and the center of the second tape reel is consistent with the center of the recording bubble. Before the recording of the voice message starts, the second tape reel is covered by the recording bubble, and a reference circle is also covered under the second tape reel. That is, as shown in FIG. 14, an icon representing the voice message is formed by stacking of three circular elements, the reference circle, the second tape reel, and the recording bubble, with the radii of R1, R2, and R3 respectively. By reducing the radius of the recording bubble, the area of the displayed part of the second tape reel is increased, thereby simulating an increase in the thickness of the second tape reel.

In a specific application, before the recording of the voice message starts, the radii of the three circular elements (the recording bubble, the second tape reel, and the reference circle) are R1, R2, and R3 respectively, and R1=R2=R3. In this case, the second tape reel is covered by the recording bubble and is in the invisible state. When the recording of the voice message starts, that the first end of the second tape segment is connected to the identity icon is displayed, that the second end of the second tape segment moves from the identity icon toward the recording bubble is displayed, and the recording of the voice message is triggered. After the recording of the voice message starts, the second end of the second tape segment continues to move toward the recording bubble. When the second end of the second tape segment is connected to the recording bubble, that is, the second end of the second tape segment reaches the icon representing the voice message, the terminal starts to display an animation in which the radius of the recording bubble gradually decreases with the recording progress of the voice message, and the second tape reel is in the visible state.

In a specific application, that the radius R1 of the recording bubble gradually decreases with the recording progress of the voice message may be quantized by using the reference circle (with the radius R3). Specifically, a recording time may be divided into several intervals in advance, and lengths of R1 in different time intervals are in different ranges. For example, when the recording time is less than 10 seconds, it may correspond to R1>=⅔×R3; when the recording time is greater than or equal to 10 seconds and less than 20 seconds, it may correspond to ⅓×R3<=R1<⅔×R3; when the recording time is greater than or equal to 20 seconds and less than or equal to 60 seconds, it may correspond to 0<R1<⅓×R3; and when the recording time is greater than 60 seconds, it may correspond to R1=0.

In this aspect, when the recording of the voice message can be implemented, the thickness of the second tape reel gradually increases with the recording progress of the voice message, so that the voice interaction object can intuitively perceive the recording progress.

In an aspect, in the recording process of the voice message, the center of the second tape reel is consistent with the center of the recording bubble, and the outer contour of the second tape reel gradually expands toward the outer contour of the recording bubble as the recording progress.

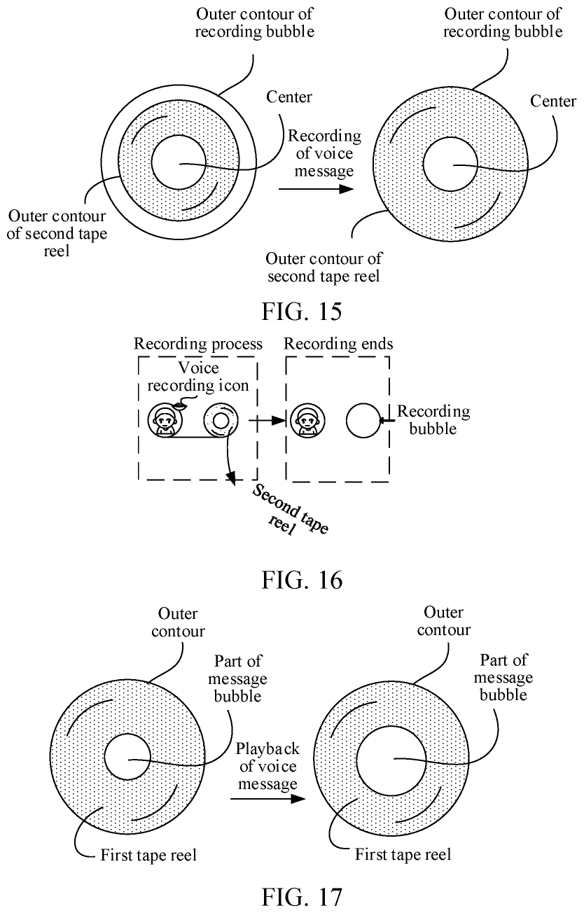

Specifically, as shown in FIG. 15, in the recording process of the voice message, the center of the second tape reel is consistent with the center of the recording bubble, and the outer contour of the second tape reel gradually expands toward the outer contour of the recording bubble with the recording progress, that is, the thickness of the second tape reel gradually increases as the recording progress increases.

In this aspect, the recording process of the voice message can be simulated by using that the thickness of the second tape reel gradually increases with the recording progress, so that the voice interaction object can intuitively perceive that the voice message is being recorded.

In an aspect, the interaction method based on a voice message further includes:
in the recording process of the voice message, adding a voice recording icon covering a part of the identity icon on the identity icon, displaying the voice recording icon, and canceling the display of the voice recording icon in response to a voice message recording end event.

The voice recording icon refers to an icon representing that the voice message is being recorded. For example, the voice recording icon may be a lip icon, which represents that the voice interaction object is inputting the voice message.

Specifically, as shown in FIG. 16, in the recording process of the voice message, the terminal adds the voice recording icon covering the part of the identity icon on the identity icon, and displays the voice recording icon, which represents that the voice message is being recorded. When the recording of the voice message ends, the terminal cancels the display of the voice recording icon in response to the voice message recording end event, which represents that the recording of the voice message has ended.

In this aspect, in the recording process of the voice message, adding the voice recording icon covering the part of the identity icon on the identity icon and displaying the voice recording icon can intuitively display that the voice message is being recorded, and canceling the display of the voice recording icon in response to the voice message recording end event can intuitively display that the recording of the voice message has ended.

In an aspect, the interaction method based on a voice message further includes:
triggering the voice message recording end event when the recording of the voice message reaches an upper limit of the message duration, and the second tape reel completely covers the recording bubble.

Specifically, the terminal counts duration of the recording of the voice message in real time. When the recording of the voice message reaches the upper limit of the message duration, the terminal displays that the second tape reel completely covers the recording bubble, and triggers the voice message recording end event. The upper limit of the message duration may be configured according to an actual application scenario. For example, the upper limit of the message duration may be one minute. That is, when the recording of the voice message reaches one minute, the terminal displays that the second tape reel completely covers the recording bubble, and triggers the voice message recording end event.

In this aspect, when the recording of the voice message reaches the upper limit of the message duration, the second tape reel completely covers the recording bubble, and the voice message recording end event is triggered, which can effectively control the message duration of the voice message and avoid repeated listening to the voice message due to an excessive message duration. In this way, a quantity of times of repeated listening to the voice message can be reduced, continuous occupation of resources can be avoided, and resource utilization can be improved.

In an aspect, in the playback process of the voice message, an outer contour of the first tape reel is consistent with an outer contour of the message bubble, a part of the message bubble is displayed inside the first tape reel, and the part of the displayed message bubble gradually increases with the playback progress.

Specifically, as shown in FIG. 17, in the playback process of the voice message, the outer contour of the first tape reel is consistent with the outer contour of the message bubble, a part of the message bubble is displayed inside the first tape reel, and the part of the displayed message bubble gradually increases with the playback progress, that is, the part of the message bubble gradually increases as the playback progress increases.

In this aspect, in the recording process of the voice message, a part of the message bubble is displayed inside the first tape reel, and the part of the displayed message bubble gradually increases with the playback progress. The playback process of the voice message can be simulated by using that the part of the message bubble gradually increases with the playback progress, so that the voice interaction object can intuitively perceive that the voice message is being played back.

In an aspect, both the first tape reel and the message bubble are in circular shapes, and a center of the first tape reel is consistent with a center of the message bubble. When the first tape reel is displayed at the message bubble, a radius of the message bubble gradually decreases, and a degree of decrease in the radius of the message bubble is positively correlated with a message duration of the voice message; and when the first end of the first tape segment is connected to the identity icon, the radius of the message bubble gradually increases with the playback progress of the voice message.

Specifically, both the first tape reel and the message bubble are in circular shapes, and the center of the first tape reel is consistent with the center of the message bubble. Before the first tape reel is displayed at the message bubble, the first tape reel is covered by the message bubble and the first tape reel is the invisible state. That is, in this case, the radius of the first tape reel is equal to the radius of the message bubble. When the first tape reel is displayed at the message bubble, the radius of the message bubble gradually decreases, and the degree of decrease in the radius of the message bubble is positively correlated with the message duration of the voice message. In this case, the first tape reel is in the visible state, and the thickness of the first tape reel is positively correlated with the message duration of the voice message. When the first end of the first tape segment is connected to the identity icon, the radius of the message bubble gradually increases with the playback progress of the voice message. That is, in the playback process of the voice message, the radius of the message bubble gradually increases with the playback progress of the voice message, and the thickness of the first tape reel gradually decreases as the radius of the message bubble gradually increases.

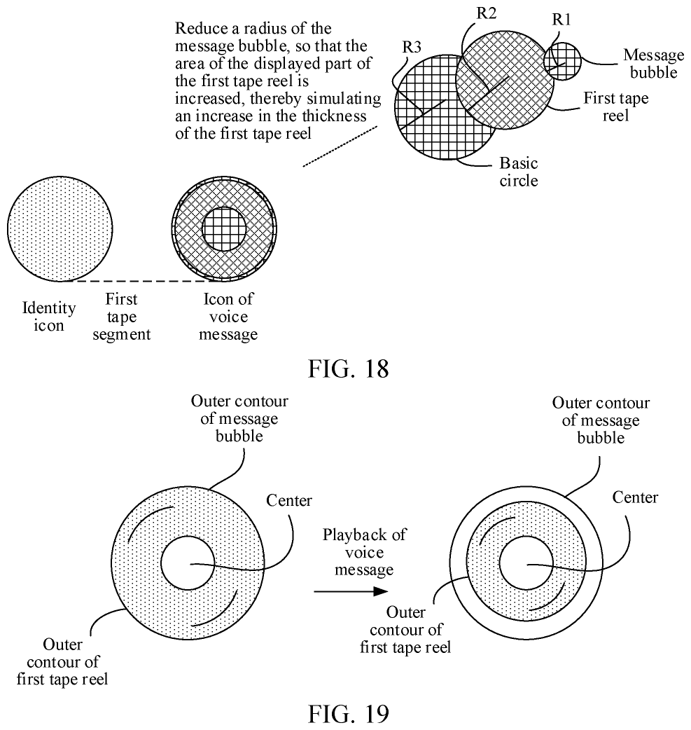

In a specific application, both the first tape reel and the message bubble are in circular shapes, and the center of the first tape reel is consistent with the center of the message bubble. Before the first tape reel is displayed at the message bubble, the first tape reel is covered by the message bubble, and a reference circle is also covered under the first tape reel. That is, as shown in FIG. 18, an icon representing the voice message is formed by stacking of three circular elements, the reference circle, the first tape reel, and the message bubble, with the radii of R1, R2, and R3 respectively. By reducing the radius of the message bubble, the area of the displayed part of the first tape reel is increased, thereby simulating an increase in the thickness of the first tape reel. By increasing the radius of the message bubble, the area of the displayed part of the first tape reel is increased, thereby simulating a decrease in the thickness of the first tape reel.

In a specific application, before the first tape reel is displayed at the message bubble, the radii of the three circular elements (the message bubble, the first tape reel, and the reference circle) are R1, R2, and R3 respectively, and R1=R2=R3. In this case, the first tape reel is covered by the message bubble and is in the invisible state. When the first tape reel is displayed at the message bubble, the radius of the message bubble gradually decreases, and the degree of decrease in the radius of the message bubble is positively correlated with the message duration of the voice message. In this case, the first tape reel is in the visible state, and the thickness of the first tape reel is positively correlated with the message duration of the voice message (when the message duration of the voice message reaches the upper limit of the message duration, R1=0). When the first end of the first tape segment is connected to the identity icon, that is, the first end of the first tape segment reaches the icon representing the voice message, the terminal starts to display an animation in which the radius of the message bubble gradually increases with the playback progress of the voice message. That is, in the playback process of the voice message, the radius of the message bubble gradually increases with the playback progress of the voice message, and the thickness of the first tape reel gradually decreases as the radius of the message bubble gradually increases.

In a specific application, the positive correlation between the degree of decrease in the radius R1 of the message bubble and the message duration of the voice message may be quantized by using the reference circle (with the radius R3). Specifically, the message duration may be divided into several intervals in advance, and lengths of R1 in different time intervals are in different ranges. For example, when the message duration is less than 10 seconds, it may correspond to R1>=⅔×R3; when the message duration is greater than or equal to 10 seconds and less than 20 seconds, it may correspond to ⅓×R3<=R1<⅔×R3; when the message duration is greater than or equal to 20 seconds and less than or equal to 60 seconds, it may correspond to 0<R1<⅓×R3; and when the message duration is greater than 60 seconds, it may correspond to R1=0.

In a specific application, that the radius R1 of the message bubble gradually increases with the playback progress of the voice message may be quantized by using the reference circle (with the radius R3). Specifically, the remaining playback duration may be divided into several intervals in advance, and lengths of R1 in different time intervals are in different ranges. For example, when the remaining playback duration is less than 10 seconds, it may correspond to R1>=⅔×R3; when the remaining playback duration is greater than or equal to 10 seconds and less than 20 seconds, it may correspond to ⅓×R3<=R1<⅔×R3; when the remaining playback duration is greater than or equal to 20 seconds and less than or equal to 60 seconds, it may correspond to 0<R1<⅓×R3; and when the remaining playback duration is greater than 60 seconds, it may correspond to R1=0.

In this aspect, when the playback of the voice message can be implemented, the thickness of the first tape reel gradually decreases with the playback progress of the voice message, so that the voice interaction object can intuitively perceive the playback progress.

In an aspect, in the playback process of the voice message, the center of the first tape reel is consistent with the center of the message bubble, and the outer contour of the first tape reel gradually shrinks toward the center of the message bubble with the playback progress.

Specifically, as shown in FIG. 19, in the playback process of the voice message, the center of the first tape reel is consistent with the center of the message bubble, and the outer contour of the first tape reel gradually shrinks toward the center of the message bubble with the playback progress, that is, the thickness of the first tape reel gradually decreases as the playback progress increases.

In this aspect, the playback process of the voice message can be simulated by using that the thickness of the first tape reel gradually decreases with the playback progress, so that the voice interaction object can intuitively perceive that the voice message is being played back.

In an aspect, when the playback of the voice message is triggered, the thickness of the first tape reel is linearly positively correlated with the message duration of the voice message.

Specifically, when the playback of the voice message is triggered, the thickness of the first tape reel is linearly positively correlated with the message duration of the voice message. That is, a longer message duration of the voice message indicates a thicker first tape reel, and a shorter message duration of the voice message indicates a thinner first tape reel. In a specific application, since the thickness of the first tape reel is linearly positively correlated with the message duration of the voice message, the thickness of the first tape reel may be determined based on a proportional relationship between the message duration of the voice message and the upper limit of the message duration.

In this aspect, the thickness of the first tape reel is linearly positively correlated with the message duration of the voice message, and the thickness of the first tape reel may be determined by using the message duration of the voice message.

In an aspect, when the message duration of the voice message is the upper limit of the message duration, and the playback of the voice message is triggered, the first tape reel completely covers the message bubble.

Specifically, when the message duration of the voice message is the upper limit of the message duration, and the playback of the voice message is triggered, the first tape reel completely covers the message bubble, that is, the message bubble is in the invisible state. In a specific application, when the message duration of the voice message is the upper limit of the message duration, and the playback of the voice message is triggered, the radius of the message bubble gradually decreases to zero, so that the first tape reel is fully displayed to cover the message bubble. The upper limit of the message duration may be configured according to an actual application scenario. For example, the upper limit of the message duration may be one minute.

In this aspect, when the message duration of the voice message is the upper limit of the message duration, and the playback of the voice message is triggered, the first tape reel completely covers the message bubble, and the corresponding first tape reel can be displayed when the message duration is the upper limit of the message duration.

In an aspect, the interaction method based on a voice message further includes:
in the playback process of the voice message, adding a voice playback icon covering a part of the identity icon on the identity icon, displaying the voice playback icon, and canceling the display of the voice playback icon in response to a voice message playback end event.

The voice playback icon refers to an icon representing that the voice message is being played back. For example, the voice playback icon may be an car icon, which represents that the voice interaction object is listening to the voice message.

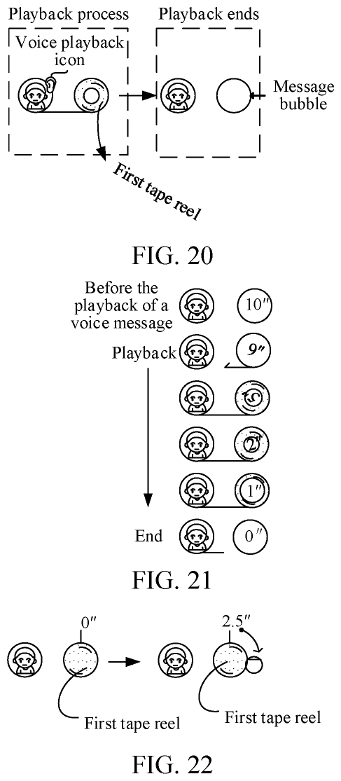

Specifically, as shown in FIG. 20, in the playback process of the voice message, the terminal adds the voice playback icon covering the part of the identity icon on the identity icon, and displays the voice playback icon, which represents that the voice message is being played back. When the playback of the voice message ends, the terminal cancels the display of the voice playback icon in response to the voice message playback end event, which represents that the playback of the voice message has ended.

In this aspect, in the playback process of the voice message, adding the voice playback icon covering the part of the identity icon on the identity icon and displaying the voice playback icon can intuitively display that the voice message is being played back, and canceling the display of the voice playback icon in response to the voice message playback end event can intuitively display that the playback of the voice message has ended.

In an aspect, the interaction method based on a voice message further includes:
displaying a digital icon corresponding to the message duration of the voice message at the message bubble of the voice message; and
in the playback process of the voice message, displaying a digital icon with a changing number, and the number in the digital icon with a changing number gradually decreases with the playback progress of the voice message.

Specifically, before the voice message is played back, the terminal displays the digital icon corresponding to the message duration of the voice message at the message bubble of the voice message, and the number in the digital icon is positively correlated with the message duration. In the playback process of the voice message, the terminal displays the digital icon with a changing number, and the number in the digital icon with a changing number gradually decreases with the playback progress of the voice message. In a specific application, when the message duration does not reach the upper limit of the message duration, the number in the corresponding digital icon of the displayed message duration is the same as the message duration, and when the message duration reaches the upper limit of the message duration, the number in the corresponding digital icon of the displayed message duration is the same as the upper limit of the message duration.

In a specific application, as shown in FIG. 21, before the voice message is played back, the digital icon corresponding to the message duration of the voice message is displayed at the message bubble of the voice message. In the playback process of the voice message, the terminal displays the digital icon with a changing number, and the number in the digital icon with a changing number gradually decreases with the playback progress of the voice message, that is, a greater playback progress indicates that the number in the digital icon is smaller. In this way, a playback countdown is implemented through the number in the digital icon.

In this aspect, by displaying the digital icon with a changing number, and by using that the number in the digital icon gradually decreases with the playback progress of the voice message, the voice playback countdown can be implemented through the number in the digital icon with a changing number, so that the voice interaction object can intuitively perceive the playback progress of the voice message.

In an aspect, the playback trigger event includes a multi-speed playback (i.e., adaptive speed playback) event; and the displaying a first tape reel at the message bubble in response to a playback trigger event for the voice message, displaying that a second end of a first tape segment is connected to the first tape reel, displaying that a first end of the first tape segment moves toward the identity icon, and triggering a playback of the voice message includes:
displaying the first tape reel at the message bubble in response to the multi-speed playback event for the voice message, displaying that the second end of the first tape segment is connected to the first tape reel, displaying that the first end of the first tape segment moves toward the identity icon, and playing back the voice message at a multi-speed corresponding to the multi-speed playback event.

The multi-speed playback event refers to an event that triggers a multi-speed playback of the voice message, which can be implemented by operating the message bubble. For example, the multi-speed playback event can be implemented through one of a tap operation, a tap and hold operation, and a double tap operation on the message bubble.

Specifically, the terminal monitors the multi-speed playback event for the voice message in real time. When detecting the multi-speed playback event for the voice message, the terminal displays the first tape reel at the message bubble in response to the multi-speed playback event for the voice message, displays that the second end of the first tape segment is connected to the first tape reel, displays that the first end of the first tape segment moves toward the identity icon, and plays back the voice message at the multi-speed corresponding to the multi-speed playback event. In a specific application, when the playback trigger event is the multi-speed playback event, in the multi-speed playback process of the voice message, the first end of the first tape segment continues to move toward the identity icon with playback progress, and the terminal displays the first tape segment connecting the identity icon and the first tape reel when the first end of the first tape segment moves to the identity icon.

In this aspect, the multi-speed playback of the voice message can be implemented in response to the multi-speed playback event.

In an aspect, the interaction method based on a voice message further includes:
in the playback process of the voice message, displaying the first tape reel at the message bubble in response to a multi-speed playback event for the voice message, and playing back the voice message at a multi-speed corresponding to the multi-speed playback event.

Specifically, in the playback process of the voice message, the terminal also monitors the multi-speed playback event for the voice message in real time. When detecting the multi-speed playback event for the voice message, the terminal displays the first tape reel at the message bubble in response to the multi-speed playback event for the voice message, and plays back the voice message at the multi-speed corresponding to the multi-speed playback event.

In this aspect, in the playback process of the voice message, the multi-speed playback of the voice message can be implemented in response to the multi-speed playback event.

In an aspect, the playing back the voice message based on a multi-speed corresponding to the multi-speed playback event includes:
calling a callback function of the multi-speed playback event, and modifying a voice playback speed attribute through the callback function; and
playing back the voice message based on a playback speed corresponding to the modified voice playback speed attribute.

The callback function refers to a function that is passed as a parameter, and the callback function is usually implemented by using a function pointer. The callback function allows a pointer of a to-be-called function to be passed to a function as a parameter, so that the function can flexibly use different methods when handling similar events. That is, a party that provides the function implementation registers the function pointer of the callback function to a caller during initialization. When a specific event or condition occurs, the caller uses the function pointer to call the callback function to process the event. In this aspect, the function pointer of the callback function is registered to the terminal. When a multi-speed playback event occurs, the terminal uses the function pointer to call the callback function to process the multi-speed playback event.

Specifically, the terminal calls the callback function of the multi-speed playback event, modifies a voice playback speed attribute through the callback function to adjust a playback speed, and plays back the voice message at the playback speed corresponding to the modified voice playback speed attribute. In a specific application, the multi-speed playback event may be a 2×-speed playback event, a 3×-speed playback event, a 0.5×-speed playback event, or the like. The multi-speed of the multi-speed playback event is not specifically limited in this aspect.

In a specific application, the multi-speed playback event may specifically be the 2×-speed playback event. The terminal displays the first tape reel at the message bubble in response to the 2×-speed playback event for the voice message, calls the callback function of the 2×-speed playback event, and modifies the voice playback speed attribute playbackRate to 2 through the callback function, so that the voice message is played back at the 2×-speed.

In this aspect, the callback function of the 2×-speed playback event is called, and the voice playback speed attribute is modified through the callback function, so that the voice message can be played at the playback speed corresponding to the modified voice playback speed attribute.

In an aspect, the playback trigger event includes a voice positioning (or playback positioning) event, and the displaying a first tape reel at the message bubble in response to a playback trigger event for the voice message, displaying that a second end of a first tape segment is connected to the first tape reel, displaying that a first end of the first tape segment moves toward the identity icon, and triggering a playback of the voice message includes:
displaying the first tape reel and a current playback progress at the message bubble in response to the voice positioning event for the voice message;
displaying a positioning playback progress indicated by the playback progress adjustment event at the message bubble in response to the playback progress adjustment event for the voice message, displaying that the second end of the first tape segment is connected to the first tape reel, displaying that the first end of the first tape segment moves toward the identity icon; and
triggering the playback of the voice message starting from the positioning playback progress of the voice message.

The voice positioning event refers to an event that positions the playback of the voice message, which can be triggered by an operation for the message bubble. For example, the operation for the message bubble may specifically refer to one of a tap operation, a tap and hold operation, and a double tap operation. The playback progress adjustment event refers to an event that adjusts the playback progress of the voice message. For example, the playback progress adjustment event may specifically be an event for adjusting the playback progress forward, that is, playing back a part that has not been played yet. In another example, the playback progress adjustment event may specifically be an event for adjusting the playback progress backward, that is, playing back a part that has already been played. For example, when the current playback progress is 0″, the playback progress adjustment event can only be an event that adjusts the playback progress forward, and when the current playback progress is not 0″, the playback progress adjustment event may be an event that adjusts the playback progress forward or an event that adjusts the playback progress backward.

Specifically, the terminal monitors the voice positioning event for the voice message in real time. When detecting the voice positioning event for the voice message, the terminal displays the first tape reel and the current playback progress at the message bubble in response to the voice positioning event for the voice message. The terminal displays a positioning playback progress indicated by the playback progress adjustment event at the message bubble in response to the playback progress adjustment event for the voice message, displays that the second end of the first tape segment is connected to the first tape reel, displays that the first end of the first tape segment moves toward the identity icon, and triggers the playback of the voice message starting from the positioning playback progress of the voice message. In a specific application, when the playback trigger event is the voice positioning event, in the playback process of the voice message starting from the positioning playback progress of the voice message, the first end of the first tape segment continues to move toward the identity icon with the playback progress. The first tape segment connecting the identity icon and the first tape reel is displayed when the first end of the first tape segment moves toward the identity icon.

In a specific application, as shown in FIG. 22, before the voice message is played back, when detecting the voice positioning event for the voice message, the terminal displays the first tape reel and the current playback progress (that is, 0″ shown in FIG. 22) at the message bubble in response to the voice positioning event for the voice message, and displays the positioning playback progress (2.5″ shown in FIG. 22) indicated by the playback progress adjustment event at the message bubble in response to the playback progress adjustment event for the voice message.

In this aspect, by displaying the first tape reel and the current playback progress at the message bubble in response to the voice positioning event for the voice message, the voice interaction object can intuitively perceive the current playback progress, so that the voice interaction object can perform adjustment from the current playback progress. By displaying the positioning playback progress indicated by the playback progress adjustment event at the message bubble in response to the playback progress adjustment event for the voice message, the voice interaction object can intuitively perceive the positioning playback progress, and by triggering the playback of the voice message starting from the positioning playback progress of the voice message, the positioning playback of the voice message can be implemented.

In an aspect, the interaction method based on a voice message further includes:
in the playback process of the voice message, displaying the first tape reel and a current playback progress at the message bubble in response to a voice positioning event for the voice message;
displaying a positioning playback progress indicated by the playback progress adjustment event at the message bubble in response to the playback progress adjustment event for the voice message; and
triggering the playback of the voice message starting from the positioning playback progress of the voice message.

Specifically, in the playback progress of the voice message, the terminal monitors the voice positioning event for the voice message in real time. When detecting the voice positioning event for the voice message, the terminal displays the first tape reel and the current playback progress at the message bubble in response to the voice positioning event for the voice message, and displays the positioning playback progress indicated by the playback progress adjustment event at the message bubble in response to the playback progress adjustment event for the voice message, and triggers the playback of the voice message starting from the positioning playback progress of the voice message.

In an aspect, the interaction method based on a voice message further includes:
recording, in response to a tap event for the message bubble, a trigger duration of a tap point corresponding to the tap event; and
triggering a voice positioning event for the voice message when the trigger duration reaches a duration threshold and the tap point is in a static state within the trigger duration. The term “tap” as used herein may include a touch interaction that includes movement, such as a swipe interaction.

Specifically, the terminal monitors the tap event for the message bubble in real time. When detecting the tap event for the message bubble, the terminal starts to record the trigger duration of the tap point corresponding to the tap event in response to the tap event for the message bubble, and triggers the voice positioning event for the voice message when the trigger duration reaches the duration threshold and the tap point is in the static state within the trigger duration, that is, the tap point is not moved. The duration threshold may be configured according to an actual application scenario.

In a specific application, the terminal marks a tap start state as true and records a first current timestamp startTime in response to the tap event for the message bubble, that is, starts to record the trigger duration of the tap point corresponding to the tap event, and triggers the voice positioning event for the voice message when the trigger duration reaches the duration threshold (that is, a duration difference between a second current timestamp nowTime and the first current timestamp startTime reaches the duration threshold), and the tap point is in the static state within the trigger duration. In a specific application, the terminal is pre-configured with a callback function corresponding to the voice positioning event. The terminal can trigger the voice positioning event for the voice message by calling the callback function corresponding to the voice positioning event.

In this aspect, by recording the trigger duration of the tap point corresponding to the tap event in response to the tap event for the message bubble, when the trigger duration reaches the duration threshold and the tap point is in the static state within the trigger duration, accurate trigger of the voice positioning event for the voice message can be implemented.

In an aspect, the displaying a positioning playback progress indicated by the playback progress adjustment event at the message bubble in response to the playback progress adjustment event for the voice message includes:
obtaining a progress adjustment position in response to the playback progress adjustment event for the voice message;
obtaining, based on an initial position corresponding to the current playback progress, a center point position of the message bubble, and the progress adjustment position, a movement angle of the progress adjustment position relative to the initial position;
determining the positioning playback progress indicated by the playback progress adjustment event based on the movement angle and a message duration of the voice message; and
displaying the positioning playback progress indicated by the playback progress adjustment event at the message bubble.

The progress adjustment position refers to a position of a progress adjustment point, the initial position refers to a position of the current playback progress, and the center point position refers to a position of a center of the message bubble. The positions herein are all relative to a position of a pre-configured origin. The pre-configured origin may be configured according to an actual application scenario. For example, the pre-configured origin may be an upper left corner vertex of a display interface of the terminal. The movement angle refers to an actual adjustment angle of the progress adjustment position relative to the initial position when the center point position is centered, and corresponds to the playback progress adjustment event.

Specifically, the terminal obtains the position of the progress adjustment tap point, that is, the progress adjustment position, based on the pre-configured origin in response to the playback progress adjustment event for the voice message, and obtains the initial position corresponding to the current playback progress and the center point position of the message bubble based on the pre-configured origin. The terminal calculates a movement angle of the progress adjustment position relative to the initial position based on the initial position corresponding to the current playback progress, the center point position of the message bubble, and the progress adjustment position, determines the positioning playback progress indicated by the playback progress adjustment event based on the movement angle and the message duration of the voice message, and displays the positioning playback progress indicated by the playback progress adjustment event at the message bubble.

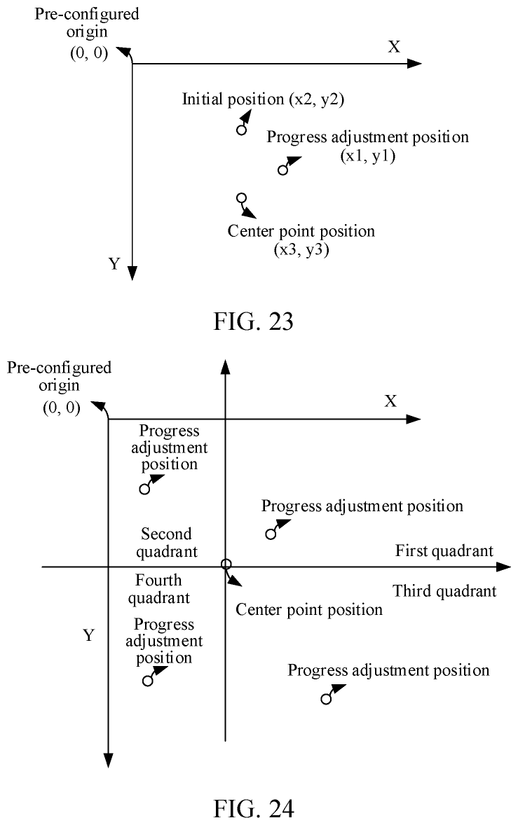

In a specific application, as shown in FIG. 23, when the pre-configured origin is the upper left corner vertex of the display interface of the terminal, the progress adjustment position (x1, y1), the initial position (x2, y2) corresponding to the current playback progress, and the center point position (x3, y3) of the message bubble may be obtained based on the pre-configured origin.

In this aspect, by obtaining the progress adjustment position in response to the playback progress adjustment event for the voice message, the movement angle of the progress adjustment position relative to the initial position can be obtained based on the initial position corresponding to the current playback progress, the center point position of the message bubble, and the progress adjustment position. Moreover, the positioning playback progress indicated by the playback progress adjustment event can be determined based on the movement angle and the message duration of the voice message, so that the positioning playback progress indicated by the playback progress adjustment event can be displayed at the message bubble.

In an aspect, the obtaining a progress adjustment position in response to the playback progress adjustment event for the voice message includes:
recording a tap point movement trajectory corresponding to the playback progress adjustment event in response to the playback progress adjustment event for the voice message; and
using a last tap point in the tap point movement trajectory as the progress adjustment position in response to a progress adjustment end event for the voice message.

Specifically, the terminal starts to record the tap point movement trajectory corresponding to the playback progress adjustment event in response to the playback progress adjustment event for the voice message, and uses a last tap point in the tap point movement trajectory as the progress adjustment position in response to the progress adjustment end event for the voice message. In a specific application, during the adjustment of the playback progress, the voice interaction object drags the message bubble on the terminal, and the terminal starts to record the corresponding tap point movement trajectory, and uses the last tap point in the tap point movement trajectory as the progress adjustment position. In a specific application, when the current playback progress is 0″, the voice interaction object may drag the message bubble clockwise, that is, the playback progress adjustment event can only be an event that adjusts the playback progress forward. When the current playback progress is not 0″, the voice interaction object may drag the message bubble clockwise or counterclockwise, that is, the playback progress adjustment event may be an event that adjusts the playback progress forward or backward.

In this aspect, by recording the tap point movement trajectory corresponding to the playback progress adjustment event in response to the playback progress adjustment event for the voice message, when the progress adjustment ends, the last tap point in the tap point movement trajectory can be used as the progress adjustment position to determine the progress adjustment position.

In an aspect, the obtaining, based on an initial position corresponding to the current playback progress, a center point position of the message bubble, and the progress adjustment position, a movement angle of the progress adjustment position relative to the initial position includes:
obtaining a relative angle of the progress adjustment position relative to the initial position based on the initial position corresponding to the current playback progress, the center point position of the message bubble, and the progress adjustment position;
comparing first coordinates of the center point position with second coordinates of the progress adjustment position to determine a quadrant in which the progress adjustment position is located, the quadrant being centered on the center point position; and
obtaining the movement angle of the progress adjustment position relative to the initial position based on the quadrant in which the progress adjustment position is located and the relative angle.

The relative angle refers to a position angle difference between the progress adjustment position and the initial position when the center point position is centered, that is, an angle difference between a first connecting line between the initial position and the center point position, and a second connecting line between the center point position and the progress adjustment position. The first coordinates of the center point position refer to coordinates of the center point position determined based on the pre-configured origin, including coordinates in two axes (a horizontal axis and a vertical axis). The second coordinates of the progress adjustment position refer to coordinates of the progress adjustment position determined based on the pre-configured origin, including coordinates in two axes (a horizontal axis and a vertical axis).

The quadrants are four regions divided by the horizontal axis and the vertical axis in a rectangular plane coordinate system (Cartesian coordinate system). Each region is referred to as a quadrant. The quadrant is centered on the origin, and the x and y axes are dividing lines. The one on the upper right is referred to as the first quadrant, the one on the upper left is referred to as the second quadrant, the one on the lower left is referred to as the third quadrant, and the one on the lower right is referred to as the fourth quadrant. In this aspect, the quadrant is centered on the center point position, that is, the x and y axes extend from the center point position as dividing lines to determine the quadrant in which the progress adjustment position is located.

Specifically, the terminal calculates the relative angle of the progress adjustment position relative to the initial position by using a cosine theorem based on the initial position corresponding to the current playback progress, the center point position of the message bubble, and the progress adjustment position, then compares the same axial coordinates in the first coordinates of the center point position and the second coordinates of the progress adjustment position to obtain a comparison result, determines the quadrant in which the progress adjustment position is located based on the comparison result, and finally obtains the movement angle of the progress adjustment position relative to the initial position based on the quadrant in which the progress adjustment position is located and the relative angle.

In a specific application, the first coordinates include a first horizontal coordinate and a first vertical coordinate, and the second coordinates include a second horizontal coordinate and a second vertical coordinate. The terminal may compare the first horizontal coordinate with the second horizontal coordinate, and the first vertical coordinate with the second vertical coordinate respectively to obtain the comparison result. The quadrant in which the progress adjustment position is located may be determined based on the comparison result.

In a specific application, as shown in FIG. 24, when the first horizontal coordinate is less than the second horizontal coordinate and the first vertical coordinate is greater than the second vertical coordinate, the quadrant in which the progress adjustment position is located may be determined to be the first quadrant. When the first horizontal coordinate is greater than the second horizontal coordinate and the first vertical coordinate is greater than the second vertical coordinate, the quadrant in which the progress adjustment position is located may be determined to be the second quadrant. When the first horizontal coordinate is greater than the second horizontal coordinate and the first vertical coordinate is less than the second vertical coordinate, the quadrant in which the progress adjustment position is located may be determined to be the third quadrant. When the first horizontal coordinate is less than the second horizontal coordinate and the first vertical coordinate is less than the second vertical coordinate, the quadrant in which the progress adjustment position is located may be determined to be the fourth quadrant.

In this aspect, the relative angle of the progress adjustment position relative to the initial position may be obtained based on the initial position corresponding to the current playback progress, the center point position of the message bubble, and the progress adjustment position, the quadrant in which the progress adjustment position is located may be determined by comparing the first coordinates of the center point position with the second coordinates of the progress adjustment position, so that the quadrant in which the progress adjustment position is located and the relative angle may be combined to implement accurate determination of the movement angle of the progress adjustment position relative to the initial position.

In an aspect, the obtaining a relative angle of the progress adjustment position relative to the initial position based on the initial position corresponding to the current playback progress, the center point position of the message bubble, and the progress adjustment position includes:
obtaining a first distance between the initial position corresponding to the current playback progress and the center point position of the message bubble, a second distance between the progress adjustment position and the center point position, and a third distance between the progress adjustment position and the initial position; and
obtaining the relative angle of the progress adjustment position relative to the initial position based on the first distance, the second distance, and the third distance.

Specifically, the terminal obtains the first distance between the initial position corresponding to the current playback progress and the center point position of the message bubble, the second distance between the progress adjustment position and the center point position, and the third distance between the progress adjustment position and the initial position, and obtains the relative angle of the progress adjustment position relative to the initial position based on the first distance, the second distance, the third distance, and the cosine theorem. The cosine theorem is a mathematical theorem that describes a relationship between lengths of three sides of a triangle and a cosine of an angle. That is, for any triangle, a square of any side is equal to twice a sum of the squares of the other two sides minus twice the product of the two sides and the cosine of an angle of the two sides.

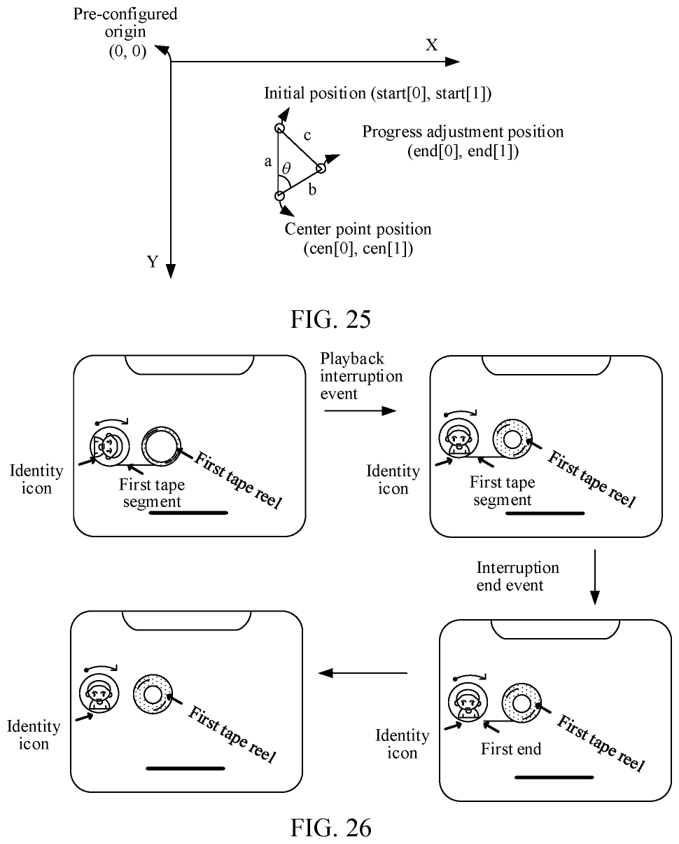

In a specific application, the terminal obtains the first distance between the initial position corresponding to the current playback progress and the center point position of the message bubble, the second distance between the progress adjustment position and the center point position, and the third distance between the progress adjustment position and the initial position based on the first coordinates of the center point position, the second coordinates of the progress adjustment position, and the third coordinates of the initial position. In a specific application, as shown in FIG. 25, the first coordinates are (cen[0], cen[1]), the second coordinates are (end[0], end[1]), and the third coordinates are (start[0], start[1]). It can be seen from the figure that the first distance is a=\sqrt{f_c_x²+f_c_y²}, where f_c_x=start[0]−cen[0], f_c_y=cen[1]−start[1]. The second distance is b=\sqrt{s_c_x²+s_c_y²}, where, s_c_x=end[0]−cen[0], s_c_y=cen[1]−end[1], and the third distance is c=\sqrt{(s_c_x−f_c_x)²+(s_c_y−f_c_y)²}.

In a specific application, the relative angle is a cosine angle that needs to be calculated, and is an angle difference between a first connecting line between the initial position and the center point position and a second connecting line between the center point position and the progress adjustment position. The terminal determines a calculation formula of the relative angle based on the cosine theorem, and then substitutes the first distance, the second distance, and the third distance into the calculation formula of the relative angle to obtain the relative angle. In a specific application, as shown in FIG. 25, if the first distance is a, the second distance is b, the third distance is c, and the relative angle θ is an angle between a and b, a calculation formula of a corresponding relative angle is

$$cos θ = \frac{{a}^{2} + {b}^{2} - {c}^{2}}{2 a b} .$$

By substituting the calculation formulas of the first distance, the second distance, and the third distance for simplification, the calculation formula of the relative angle may be obtained as θ=Math.acos((f_c_x*s_c_x+f_c_y*s_c_y)/d), where d=Math.sqrt(f_c_x*f_c_x+f_c_y*f_c_y)*Math.sqrt(s_c_x*s_c_x+s_c_y*s_c_y), Math.acos( ) represents an inverse cosine function, Math.sqrt( ) represents a square root calculation, f_c_x*s_c_x represents a product of f_c_x and s_c_x, f_c_y*s_c_y represents a product of f_c_y and s_c_y, f_c_x*f_c_x represents a square of f_c_x, f_c_y*f_c_y represents a square of f_c_y, s_c_x*s_c_x represents a square of s_c_x, and s_c_y*s_c_y represents a square of s_c_y.

In this aspect, by obtaining the first distance, the second distance, and the third distance, the relative angle of the progress adjustment position relative to the initial position may be calculated based on the first distance, the second distance, and the third distance.

In an aspect, the obtaining the movement angle of the progress adjustment position relative to the initial position based on the quadrant in which the progress adjustment position is located and the relative angle includes:
when the quadrant in which the progress adjustment position is located is the first quadrant or the fourth quadrant, using the relative angle as the movement angle of the progress adjustment position relative to the initial position.

Specifically, when the quadrant in which the progress adjustment position is located is the first quadrant or the fourth quadrant, the terminal directly uses the relative angle as the movement angle of the progress adjustment position relative to the initial position.

In an aspect, the obtaining the movement angle of the progress adjustment position relative to the initial position based on the quadrant in which the progress adjustment position is located and the relative angle includes:
when the quadrant in which the progress adjustment position is located is the second quadrant or the third quadrant, using an angle difference between a pre-configured angle and the relative angle as the movement angle of the progress adjustment position relative to the initial position.

Specifically, when the quadrant in which the progress adjustment position is located is the second quadrant or the third quadrant, the terminal uses the angle difference between the pre-configured angle and the relative angle as the movement angle of the progress adjustment position relative to the initial position. The pre-configured angle is 2π.

In an aspect, the interaction method based on a voice message further includes:
in the playback process of the voice message, displaying the identity icon and the first tape reel in response to a playback interruption event for the voice message, and that the thickness of the first tape reel is positively correlated with a message duration of the voice message, and triggering to stop the playback of the voice message.

The playback interruption event refers to an event that the terminal plays back the voice message, which can be triggered by an operation for the message bubble. For example, the operation for the message bubble may specifically refer to one of a tap operation, a tap and hold operation, and a double tap operation.

Specifically, in the playback process of the voice message, the terminal monitors the playback interruption event for the voice message in real time. When detecting the playback interruption event for the voice message, the terminal displays the identity icon and the first tape reel in response to the playback interruption event for the voice message, and that the thickness of the first tape reel is positively correlated with the message duration of the voice message, and triggers to stop the playback of the voice message. In a specific application, the thickness of the first tape reel is linearly positively correlated with the message duration of the voice message.

In this aspect, in the playback process of the voice message, by displaying the identity icon and the first tape reel in response to the playback interruption event for the voice message, and that the thickness of the first tape reel is positively correlated with the message duration of the voice message, an initial state of the playback of the voice message can be simulated, so that the voice interaction object can intuitively perceive that the playback of the voice message is interrupted and the reel has returned to the initial state of the playback of the voice message.

In an aspect, the displaying the identity icon and the first tape reel in response to a playback interruption event for the voice message, and that the thickness of the first tape reel is positively correlated with a message duration of the voice message, and triggering to stop the playback of the voice message includes:
displaying, in response to the playback interruption event for the voice message, that at least one of the identity icon or the first tape reel rotates, the thickness of the first tape reel gradually increases, a degree of increase in the thickness of the first tape reel is positively correlated with the playback progress of the voice message, and triggering to stop the playback of the voice message;
displaying that the first end of the first tape segment moves from the identity icon toward the first tape reel in response to an interruption end event for the voice message; and
displaying the first tape reel in a case that the first end of the first tape segment moves toward the first tape reel, and that the thickness of the first tape reel is positively correlated with the message duration of the voice message.

Specifically, the terminal displays, in response to the playback interruption event for the voice message, that at least one of the identity icon or the first tape reel rotates, the thickness of the first tape reel gradually increases, and a degree of increase in the thickness of the first tape reel is positively correlated with the playback progress of the voice message, that is, a longer playback progress of the voice message indicates that a thicker first tape reel, and triggers to stop the playback of the voice message. The terminal displays, in response to the interruption end event for the voice message, that the first end of the first tape segment moves from the identity icon toward the first tape reel, and displays the first tape reel when the first end of the first tape segment moves toward the first tape reel, and that the thickness of the first tape reel is positively correlated with the message duration of the voice message.

In a specific application, the terminal displays that the identity icon rotates, and the first tape reel does not rotate. A rotation direction of the identity icon may be pre-configured according to an actual application scenario. For example, the rotation direction may be clockwise or counterclockwise. In a specific application, the terminal displays that the identity icon does not rotate, and the first tape reel rotates. A rotation direction of the first tape reel may be pre-configured according to an actual application scenario. For example, the rotation direction may be clockwise or counterclockwise.

In a specific application, the terminal displays that the identity icon and the first tape reel rotate at the same time. The rotation directions of the identity icon and the first tape reel may be pre-configured according to an actual application scenario, and may be the same or different. For example, when the identity icon and the first tape reel rotate at the same time, a rotation mode may be that the identity icon rotates clockwise and the first tape reel rotates counterclockwise, or may be that the identity icon rotates counterclockwise and the first tape reel rotates clockwise.

In a specific application, as shown in FIG. 26, the terminal displays, in response to the playback interruption event for the voice message, that the identity icon rotates, the thickness of the first tape reel gradually increases, and the degree of increase in the thickness of the first tape reel is positively correlated with the playback progress of the voice message. The terminal displays, in response to the interruption end event for the voice message, that the first end of the first tape segment moves from the identity icon toward the first tape reel, and displays the first tape reel when the first end of the first tape segment moves toward the first tape reel, and that the thickness of the first tape reel is positively correlated with the message duration of the voice message.

In this aspect, by using that at least one of the identity icon or the first tape reel rotates, the thickness of the first tape reel gradually increases, and the degree of increase in the thickness of the first tape reel is positively correlated with the playback progress of the voice message, and by displaying, in response to the interruption end event for the voice message, that the first end of the first tape segment moves from the identity icon toward the first tape reel, and displaying the first tape reel when the first end of the first tape reel moves toward the first tape reel, and that the thickness of the first tape reel is positively correlated with the message duration of the voice message, a reverse playback of the first tape reel can be simulated, and the reel gradually returns to the initial state of the playback of the voice message, so that the voice interaction object can intuitively perceive that the playback of the voice message is interrupted and the reel gradually returns to the initial state of the playback of the voice message.

In an aspect, the interaction method based on a voice message of this disclosure is described by being applied to a communication application, and an example in which the method is applied to a terminal is used for description.

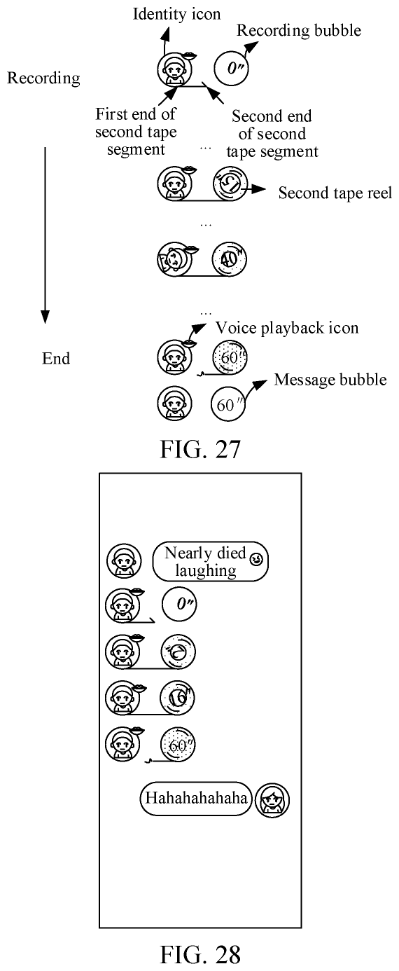

In a recording stage of the voice message, as shown in FIG. 27, the terminal displays the identity icon and the recording bubble in response to the voice message recording event, displays that the first end of the second tape segment is connected to the identity icon, displays that the second end of the second tape segment moves from the identity icon toward the recording bubble, and triggers the recording of the voice message. When the second end of the second tape segment is connected to the recording bubble, the second tape reel is displayed at the recording bubble, and the recording of the voice message is triggered. In the recording process of the voice message, the terminal displays that at least one of the second tape reel or the identity icon rotates, and that the thickness of the second tape reel gradually increases with the recording progress of the voice message, and displays the second tape segment connecting the identity icon and the second tape reel within at least part of the time period of the recording process. The terminal displays that the first end of the second tape segment moves from the identity icon toward the second tape reel in response to the voice message recording end event, and cancels the display of the second tape reel and displays the message bubble of the voice message when the first end of the second tape segment moves to the second tape reel. In the recording process of the voice message, the terminal adds a voice recording icon covering a part of the identity icon on the identity icon, displays the voice recording icon, and cancels the display of the voice recording icon in response to a voice message recording end event. In the recording process of the voice message, the terminal displays a digital icon with a changing number, and the number in the digital icon with a changing number gradually increases with the recording progress of the voice message. Further, as shown in FIG. 27, in the recording process of the voice message, the terminal adds a voice recording icon covering a part of the identity icon on the identity icon, displays the voice recording icon, and cancels the display of the voice recording icon in response to the voice message recording end event.

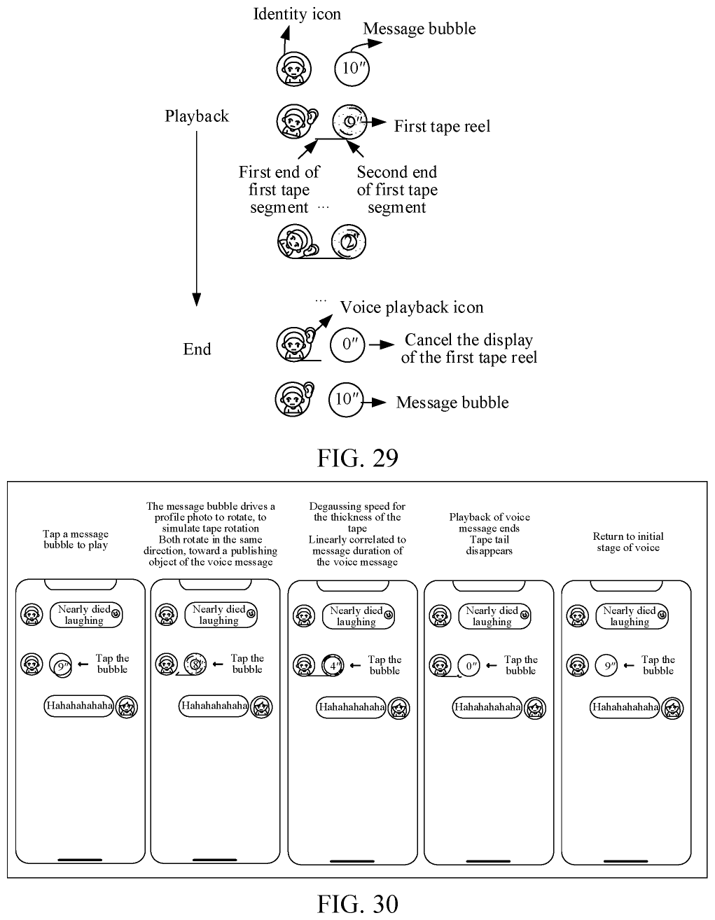

In a specific application, as shown in FIG. 28, the terminal displays the identity icon and the recording bubble (a 0″ circular bubble in FIG. 28) in response to the voice message recording event, adds the voice recording icon (a lip icon in FIG. 28) covering a part of the identity icon on the identity icon, displays the voice recording icon, displays that the second end of the second tape segment moves from the identity icon toward the recording bubble, and triggers the recording of the voice message. In the recording process of the voice message, the terminal displays a digital icon with a changing number, and the number in the digital icon gradually increases with the recording progress of the voice message (as shown in FIG. 28, as the recording progress of the voice message, the digital icon with the changing number is 2″, 16″, and 60″ respectively). The terminal displays that at least one of the second tape reel or the identity icon rotates, and the thickness of the second tape reel gradually increases with the recording progress of the voice message (as shown in FIG. 28, as the recording progress is 2″, 16″, and 60″, the thickness of the second tape reel gradually increases), and displays the second tape segment connecting the identity icon and the second tape reel within at least part of the time period of the recording process (as shown in FIG. 28, the second tape segment connecting the identity icon and the second tape reel is displayed when the recording progress is 2″ and 16″). In response to the voice message recording end event (as shown in FIG. 28, the message duration of the voice message reaches the upper limit of the message duration of 60″), the terminal displays that the first end of the second tape segment moves from the identity icon toward the second tape reel, and cancels the display of the second tape reel and displays the message bubble of the voice message when the first end of the second tape segment moves to the second tape reel (this part is not shown in FIG. 28). In a playback stage of the voice message, as shown in FIG. 29, the terminal displays the first tape reel at the message bubble in response to the playback trigger event for the voice message, displays that the second end of the first tape segment is connected to the first tape reel, displays that the first end of the first tape segment moves toward the identity icon, and triggers the playback of the voice message. In the playback process of the voice message, the terminal displays that at least one of the first tape reel or the identity icon rotates, and the thickness of the first tape reel gradually decreases with the playback progress of the voice message, and displays the first tape segment connecting the identity icon and the first tape reel within at least part of the time period of the playback process. The terminal cancels the display of the first tape reel in response to the playback end event for the voice message, and as the display of the first tape reel is canceled, displays that the second end of the first tape segment moves from the first tape reel toward the identity icon, and cancels the display of the first tape segment and restores the display of the message bubble when the second end of the first tape segment moves to the identity icon. Before the playback of the voice message starts, the terminal displays the digital icon corresponding to the message duration of the voice message at the message bubble of the voice message, and displays the digital icon with a changing number in the playback process of the voice message, and that the number in the digital icon with a changing number gradually decreases with the playback progress of the voice message. Further, as shown in FIG. 29, in the playback process of the voice message, the terminal adds a voice playback icon covering a part of the identity icon on the identity icon, displays the voice playback icon, and cancels the display of the voice playback icon in response to a voice message playback end event.

In a specific application, as shown in FIG. 30, the terminal displays the message bubble of the voice message and a corresponding profile photo (that is, the identity icon), and displays a digital icon corresponding to the message duration of the voice message at the message bubble (that is, 9″ as shown in FIG. 30). The terminal displays the first tape reel at the message bubble in response to the playback trigger event (tap the message bubble to play) of the voice message, displays that the second end of the first tape segment is connected to the first tape reel, displays that the first end of the first tape segment moves toward the profile photo, and triggers the playback of the voice message. In the playback process of the voice message, the terminal displays the digital icon with a changing number, and the number in the digital icon with a changing number gradually decreases with the playback progress of the voice message (as shown in FIG. 30, for a voice message that originally has a duration of 9″, as the playing progress of the voice message, the number in the digital icon gradually changes to 8″, 4″, and 0″, and the number in the displayed digital icon is the remaining playback duration). In the playback process of the voice message, the message bubble drives the profile photo to rotate, to simulate tape rotation, that is, displays that the first tape reel and the profile photo rotate, and both rotate in the same direction, toward the publishing object of the voice message. In the playback process of the voice message, the displayed thickness of the first tape reel gradually decreases with the playback progress of the voice message, that is, a degaussing speed of the thickness of the tape is linearly correlated with the message duration of the voice message (it can be seen from FIG. 30 that, the thickness of the first tape reel when the remaining playback duration is 8″ is greater than the thickness of the first tape reel when the remaining playback duration is 4″). The terminal displays the first tape segment connecting the profile photo and the first tape reel within at least part of the time period of the playback process (as shown in FIG. 30, when the remaining playback duration is 4″, the first tape segment connecting the profile photo and the first tape reel is displayed). The terminal cancels the display of the first tape reel in response to the playback end event for the voice message, and as the display of the first tape reel is canceled, displays that the second end of the first tape segment moves from the first tape reel toward the profile photo, that is, the playback of the voice message ends and a tape tail disappears, and cancels the display of the first tape segment and restores the display of the message bubble when the second end of the first tape segment moves to the profile photo, to return to the initial stage of displaying the message bubble of the voice message and the corresponding profile photo.

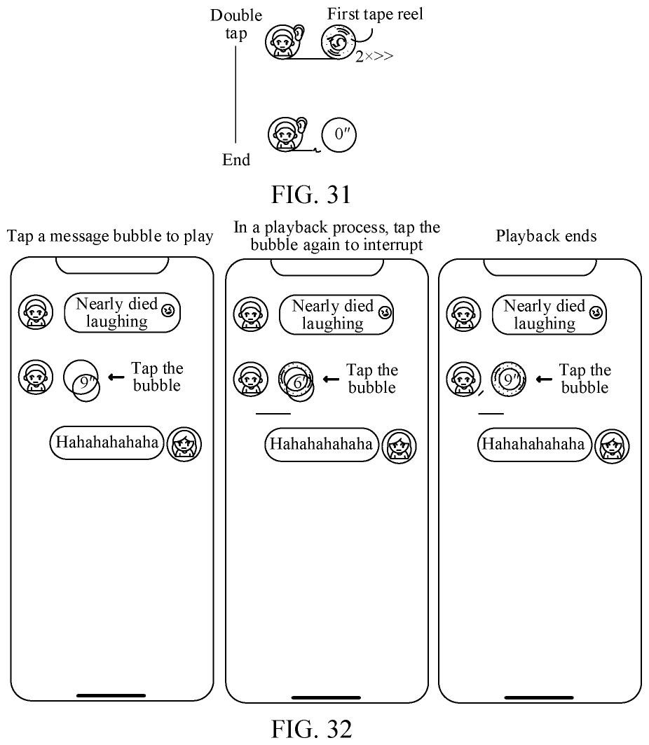

In a specific application, the playback trigger event includes the multi-speed playback event. Before the voice message is played back and in the playback process, the terminal displays the first tape reel at the message bubble in response to the multi-speed playback event for the voice message, calls the callback function of the multi-speed playback event, modifies the voice playback speed attribute through the callback function, and plays back the voice message at the corresponding playback speed of the modified voice playback speed attribute. In a specific application, as shown in FIG. 31, the multi-speed playback event may specifically be a 2×-speed playback event (represented by 2×>> in FIG. 31) and is triggered by double-tap. The terminal displays the first tape reel at the message bubble in response to the 2×-speed playback event for the voice message, calls the callback function of the 2×-speed playback event, modifies the voice playback speed attribute through the callback function, and plays back the voice message at the corresponding playback speed of the modified voice playback speed attribute. In the playback process of the voice message, the terminal adds a voice playback icon (that is, an car icon representing listening in FIG. 31) covering a part of the identity icon on the identity icon, displays the voice playback icon, and cancels the display of the voice playback icon in response to a voice message playback end event.

In a specific application, the playback trigger event includes a voice positioning event. The terminal can respond to the voice positioning event for the voice message before the voice message is played back and in the playback process. In a specific application, the terminal records, in response to the tap event for the message bubble, the trigger duration of the tap point corresponding to the tap event, and triggers the voice positioning event for the voice message when the trigger duration reaches the duration threshold and the tap point is in the static state within the trigger duration. In a specific application, the terminal displays the first tape reel and the current playback progress at the message bubble in response to the voice positioning event for the voice message, displays the positioning playback progress indicated by the playback progress adjustment event at the message bubble in response to the playback progress adjustment event for the voice message, and triggers the playback of the voice message starting from the positioning playback progress of the voice message.

In a specific application, the terminal records a tap point movement trajectory corresponding to the playback progress adjustment event in response to the playback progress adjustment event for the voice message, uses the last tap point in the tap point movement trajectory as the progress adjustment position in response to the progress adjustment end event for the voice message, obtains the first distance between the initial position corresponding to the current playback progress and the center point position of the message bubble, the second distance between the progress adjustment position and the center point position, and the third distance between the progress adjustment position and the initial position, obtains the relative angle of the progress adjustment position relative to the initial position based on the first distance, the second distance, and the third distance, compares the first coordinates of the center point position with the second coordinates of the progress adjustment position to determine a quadrant in which the progress adjustment position is located, the quadrant being centered on the center point position, obtains the movement angle of the progress adjustment position relative to the initial position based on the quadrant in which the progress adjustment position is located and the relative angle, determines the positioning playback progress indicated by the playback progress adjustment event based on the movement angle and the message duration of the voice message, and displays the positioning playback progress indicated by the playback progress adjustment event at the message bubble. When the quadrant in which the progress adjustment position is located is the first quadrant or the fourth quadrant, the terminal uses the relative angle as the movement angle of the progress adjustment position relative to the initial position. When the quadrant in which the progress adjustment position is located is the second quadrant or the third quadrant, the terminal uses the angle difference between the pre-configured angle and the relative angle as the movement angle of the progress adjustment position relative to the initial position.

In a specific application, as shown in FIG. 26, when detecting the playback interruption event for the voice message, the terminals displays, in response to the playback interruption event for the voice message, that at least one of the identity icon or the first tape reel rotates, the thickness of the first tape reel gradually increases, and a degree of increase in the thickness of the first tape reel is positively correlated with the playback progress of the voice message, and triggers to stop the playback of the voice message. The terminal displays that the first end of the first tape segment moves from the identity icon toward the first tape reel in response to the interruption end event for the voice message. The terminal displays the firs tape reel when the first end of the first tape reel moves to the first tape reel, and displays that the thickness of the first tape reel is positively correlated with the message duration of the voice message.

In a specific application, as shown in FIG. 32, the terminal triggers the playback of the voice message in response to the playback trigger event for the voice message (tap the message bubble to play). In the playback process of the voice message, when detecting the playback interruption event for the voice message (in the playback process, tap the bubble again to interrupt), the terminal triggers to stop the playback of the voice message in response to the playback interruption event for the voice message, and displays that the first end of the first tape segment moves from the identity icon toward the first tape reel in response to the interruption end event for the voice message. The terminal displays the first tape reel when the first end of the first tape reel moves toward the first tape reel, and that the thickness of the first tape reel is positively correlated with the message duration of the voice message (this part is not shown in FIG. 32).

It is to be understood that, steps in flowcharts of the foregoing aspects are displayed in sequence based on indication of arrows, but the steps are not necessarily performed in sequence based on a sequence indicated by the arrows. Unless otherwise explicitly specified in this specification, the steps are performed without any strict sequence limit, and may be performed in other sequences. In addition, at least some steps in the foregoing aspects may include a plurality of steps or a plurality of stages, and these steps or stages are not necessarily performed at a same time instant, but may be performed at different time instants. The steps or stages are not necessarily performed in sequence, but may be performed by turn or alternately with other steps or at least part of steps or stages in other steps.

During the playback of a traditional voice message, bubbles with different lengths are used, which is inefficient in screen drawing. This disclosure unifies the style and can only use numbers to indicate the voice length, and there is no need to draw bubbles with a plurality of lengths. In addition, this disclosure introduces effect simulation of the tape, and the effect simulation during listening is more consistent with the intuitive perception of the voice interaction object. During recording, the voice interaction object can intuitively perceive where the recording of the voice message is going through the thickness of the tape and the state of the object. That is, this disclosure simulates the recording and playback of the voice message by introducing the increase and decrease effects of the tape in real time, and through a plurality of levels of overlay rendering, which is more consistent with the intuitive perception of the voice interaction object and the voice interaction object can intuitively perceive where the playback or recording is going.

An aspect of this disclosure further provides an interaction apparatus based on a voice message for implementing the foregoing interaction method based on a voice message. The implementation solution for resolving the problem provided by this apparatus is similar to the implementation solution recorded in the foregoing method. Therefore, for the specific limitations in one or more aspects of the interaction apparatus based on a voice message provided below, reference may be made to the foregoing limitations for the interaction method based on a voice message, and the description is not repeated herein again.

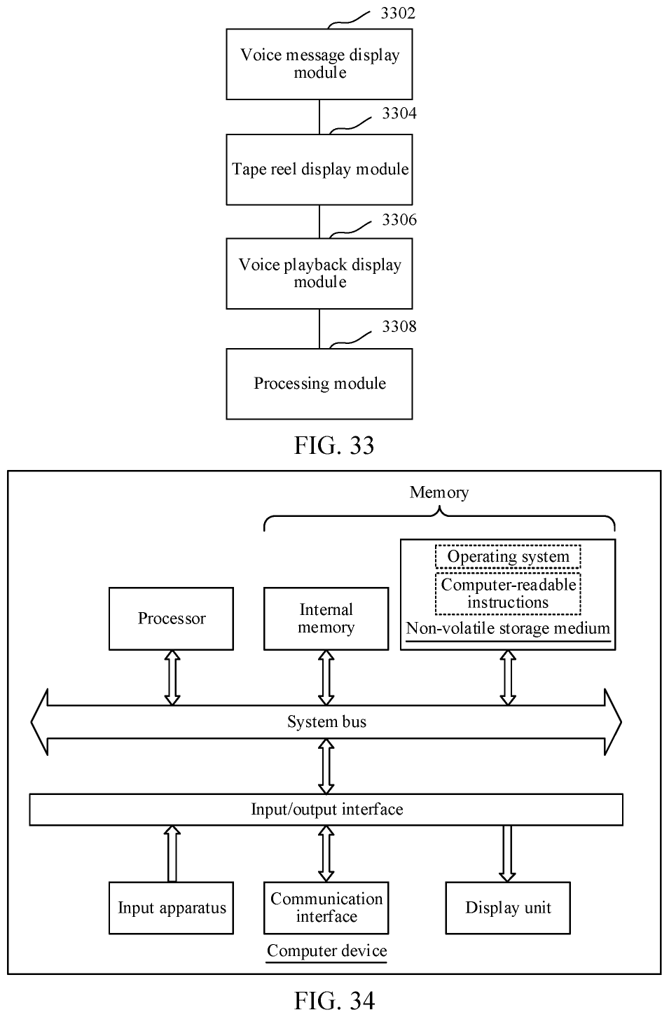

In an aspect, as shown in FIG. 33, an interaction apparatus based on a voice message is provided, including: a voice message display module 3302, a tape reel display module 3304, a voice playback display module 3306, and a processing module 3308.

The voice message display module 3302, configured to display a message bubble of a voice message and a corresponding identity icon;
the tape reel display module 3304, configured to: display a first tape reel at the message bubble in response to a playback trigger event for the voice message, display that a second end of a first tape segment is connected to the first tape reel, display that a first end of the first tape segment moves toward the identity icon, and trigger a playback of the voice message;
the voice playback display module 3306, configured to: in a playback process of the voice message, display that at least one of the first tape reel or the identity icon rotates, and a thickness of the first tape reel gradually decreases with a playback progress of the voice message, and display the first tape segment connecting the identity icon and the first tape reel within at least part of the time period of the playback process;
the processing module 3308, configured to cancel the display of the first tape reel in response to a playback end event for the voice message; and as the display of the first tape reel is canceled, display that the second end of the first tape segment moves from the first tape reel toward the identity icon, and cancel the display of the first tape segment in a case that the second end of the first tape segment moves to the identity icon.

In the interaction apparatus based on a voice message, the message bubble of the voice message and the corresponding identity icon are displayed, the first tape reel is displayed at the message bubble in response to the playback trigger event for the voice message, that the second end of the first tape segment is connected to the first tape reel is displayed, that the first end of the first tape segment moves toward the identity icon is displayed, and the playback of the voice message is triggered. In this way, the display form when the playback of the voice message starts can be enriched, so that the voice interaction object can intuitively perceive that the playback of the voice message starts. In the playback process of the voice message, by using the first tape segment to display that the first tape reel rotates together with the identity icon, and by using that the thickness of the first tape reel gradually decreases with the playback progress of the voice message, a publishing party of the voice message can be displayed, and the change of the playback progress of the voice message can be simulated by using the thickness change during the tape reel rotation, so that the voice interaction object can intuitively perceive the playback progress, and there is no need to listen to the voice message repeatedly. This can reduce a quantity of times of repeated listening to the voice message, avoid continuous occupation of resources, and improve resource utilization. In response to the playback end event for the voice message, the display of the first tape reel is canceled, and as the display of the first tape reel is canceled, that the second end of the first tape segment moves from the first tape reel toward the identity icon is displayed, and the display of the first tape segment is canceled when the second end of the first tape segment moves to the identity icon. As the display of the first tape reel is canceled, a playback end state of the voice message can be simulated by using the movement of the second end of the first tape segment, so that the voice interaction object can intuitively perceive the end of the playback of the voice message.

In an aspect, the voice message display module is further configured to display the identity icon and the second tape reel in response to the voice message recording event, and trigger the recording of the voice message; in the recording process of the voice message, display that at least one of the second tape reel or the identity icon rotates, and a thickness of the second tape reel gradually increases with the recording progress of the voice message, and display the second tape segment connecting the identity icon and the second tape reel within at least part of the time period of the recording process; and cancel the display of the second tape reel in response to the voice message recording end event, and display the message bubble of the voice message.

In an aspect, the voice message display module is further configured to display the identity icon and the recording bubble in response to the voice message recording event; display that the first end of the second tape segment is connected to the identity icon, display that the second end of the second tape segment moves from the identity icon toward the recording bubble, and trigger the recording of the voice message; and display the second tape reel at the recording bubble when the second end of the second tape segment is connected to the recording bubble.

In an aspect, the voice message display module is further configured to display that the first end of the second tape segment moves from the identity icon toward the second tape reel in response to the voice message recording end event; and cancel the display of the second tape reel and display the message bubble of the voice message when the first end of the second tape segment moves to the second tape reel.

In an aspect, in the recording process of the voice message, an outer contour of the second tape reel is consistent with an outer contour of the recording bubble, a part of the recording bubble is displayed inside the second tape reel, and the part of the displayed recording bubble gradually decreases with the recording progress.

In an aspect, both the second tape reel and the recording bubble are in circular shapes, and a center of the second tape reel is consistent with a center of the recording bubble. Before the recording of the voice message starts, the second tape reel is covered by the recording bubble, and the second tape reel is in an invisible state; and in a case that the second end of the second tape segment is connected to the recording bubble, a radius of the recording bubble gradually decreases with the recording progress of the voice message, and the second tape reel is in a visible state.

In an aspect, in the recording process of the voice message, the center of the second tape reel is consistent with the center of the recording bubble, and the outer contour of the second tape reel gradually expands toward the outer contour of the recording bubble as the recording progress.

In an aspect, the voice message display module is further configured to: in the recording process of the voice message, add a voice recording icon covering a part of the identity icon on the identity icon, display the voice recording icon, and cancel the display of the voice recording icon in response to a voice message recording end event.

In an aspect, the voice message display module is further configured to trigger the voice message recording end event when the recording of the voice message reaches an upper limit of the message duration, and the second tape reel completely covers the recording bubble.

In an aspect, in the playback process of the voice message, an outer contour of the first tape reel is consistent with an outer contour of the message bubble, a part of the message bubble is displayed inside the first tape reel, and the part of the displayed message bubble gradually increases with the playback progress.

In an aspect, both the first tape reel and the message bubble are in circular shapes, and a center of the first tape reel is consistent with a center of the message bubble. When the first tape reel is displayed at the message bubble, a radius of the message bubble gradually decreases, and a degree of decrease in the radius of the message bubble is positively correlated with a message duration of the voice message; and when the first end of the first tape segment is connected to the identity icon, the radius of the message bubble gradually increases with the playback progress of the voice message.

In an aspect, in the playback process of the voice message, the center of the first tape reel is consistent with the center of the message bubble, and the outer contour of the first tape reel gradually shrinks toward the center of the message bubble with the playback progress.

In an aspect, when the playback of the voice message is triggered, the thickness of the first tape reel is linearly positively correlated with the message duration of the voice message.

In an aspect, when the message duration of the voice message is the upper limit of the message duration, and the playback of the voice message is triggered, the first tape reel completely covers the message bubble.

In an aspect, the voice message display module is further configured to: in the playback process of the voice message, add a voice playback icon covering a part of the identity icon on the identity icon, display the voice playback icon, and cancel the display of the voice playback icon in response to a voice message playback end event.

In an aspect, the interaction apparatus based on a voice message further includes a digital icon display module. The digital icon display module is configured to: display the digital icon corresponding to the message duration of the voice message at the message bubble of the voice message, and display the digital icon with a changing number in the playback process of the voice message, and that the number in the digital icon with a changing number gradually decreases with the playback progress of the voice message.

In an aspect, the playback trigger event includes a multi-speed playback event, and the tape reel display module includes a multi-speed playback unit. The multi-speed playback unit is configured to display the first tape reel at the message bubble in response to the multi-speed playback event for the voice message, display that the second end of the first tape segment is connected to the first tape reel, display that the first end of the first tape segment moves toward the identity icon, and play back the voice message at a multi-speed corresponding to the multi-speed playback event.

In an aspect, the multi-speed playback unit is further configured to: in the playback process of the voice message, display the first tape reel at the message bubble in response to a multi-speed playback event for the voice message, and play back the voice message at a multi-speed corresponding to the multi-speed playback event.

In an aspect, the multi-speed playback unit is further configured to: call the callback function of the multi-speed playback event, modify a voice playback speed attribute through the callback function, and play back the voice message at the playback speed corresponding to the modified voice playback speed attribute.

In an aspect, the playback trigger event includes a voice positioning event, and the tape reel display module includes a voice positioning unit. The voice positioning unit is configured to: display the first tape reel and the current playback progress at the message bubble in response to the voice positioning event for the voice message, display a positioning playback progress indicated by the playback progress adjustment event at the message bubble in response to the playback progress adjustment event for the voice message, display that the second end of the first tape segment is connected to the first tape reel, display that the first end of the first tape segment moves toward the identity icon, and trigger the playback of the voice message starting from the positioning playback progress of the voice message.

In an aspect, the voice positioning unit is further configured to: in the playback process of the voice message, display the first tape reel and the current playback progress at the message bubble in response to the voice positioning event for the voice message, display the positioning playback progress indicated by the playback progress adjustment event at the message bubble in response to the playback progress adjustment event for the voice message, and trigger the playback of the voice message starting from the positioning playback progress of the voice message.

In an aspect, the voice positioning unit is further configured to: record the trigger duration of the tap point corresponding to the tap event in response to the tap event of the message bubble, and trigger the voice positioning event for the voice message when the trigger duration reaches the duration threshold and the tap point is in the static state within the trigger duration.

In an aspect, the voice positioning unit is further configured to: obtain the progress adjustment position in response to the playback progress adjustment event for the voice message, obtain the movement angle of the progress adjustment position relative to the initial position based on the initial position corresponding to the current playback progress, the center point position of the message bubble, and the progress adjustment position, determine the positioning playback progress indicated by the playback progress adjustment event based on the movement angle and the message duration of the voice message, and display the positioning playback progress indicated by the playback progress adjustment event at the message bubble.

In an aspect, the voice positioning unit is further configured to: record the tap point movement trajectory corresponding to the playback progress adjustment event in response to the playback progress adjustment event for the voice message, and use a last tap point in the tap point movement trajectory as the progress adjustment position in response to the progress adjustment end event for the voice message.

In an aspect, the voice positioning unit is further configured to: obtain the relative angle of the progress adjustment position relative to the initial position based on the initial position corresponding to the current playback progress, the center point position of the message bubble, and the progress adjustment position, compare the first coordinates of the center point position with the second coordinates of the progress adjustment position to determine the quadrant in which the progress adjustment position is located, the quadrant being centered on the center point position, and obtain the movement angle of the progress adjustment position relative to the initial position based on the quadrant in which the progress adjustment position is located and the relative angle.

In an aspect, the voice positioning unit is further configured to: obtain the first distance between the initial position corresponding to the current playback progress and the center point position of the message bubble, the second distance between the progress adjustment position and the center point position, and the third distance between the progress adjustment position and the initial position, and obtain the relative angle of the progress adjustment position relative to the initial position based on the first distance, the second distance, and the third distance.

In an aspect, the voice positioning unit is further configured to: when the quadrant in which the progress adjustment position is located is the first quadrant or the fourth quadrant, use the relative angle as the movement angle of the progress adjustment position relative to the initial position.

In an aspect, the voice positioning unit is further configured to: when the quadrant in which the progress adjustment position is located is the second quadrant or the third quadrant, an angle difference between a pre-configured angle and the relative angle as the movement angle of the progress adjustment position relative to the initial position.

In an aspect, the interaction apparatus based on a voice message further includes a playback interruption processing module. The playback interruption processing module is configured to: in the playback process of the voice message, display the identity icon and the first tape reel in response to a playback interruption event for the voice message, and that the thickness of the first tape reel is positively correlated with a message duration of the voice message, and trigger to stop the playback of the voice message.

In an aspect, the playback interruption processing module is further configured to display, in response to the playback interruption event for the voice message, that at least one of the identity icon or the first tape reel rotates, the thickness of the first tape reel gradually increases, and a degree of increase in the thickness of the first tape reel is positively correlated with the playback progress of the voice message, and triggers to stop the playback of the voice message; and display, in response to the interruption end event for the voice message, that the first end of the first tape segment moves from the identity icon toward the first tape reel; and display the first tape reel when the first end of the first tape segment moves to the first tape reel, and that the thickness of the first tape reel is positively correlated with the message duration of the voice message.

The modules in the foregoing interaction apparatus based on a voice message may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

In an aspect, a computer device is provided. The computer device may be a terminal, and an internal structure diagram thereof may be shown in FIG. 34. The computer device includes a processor (e.g., processing circuitry), a memory (e.g., a non-transitory computer-readable storage medium), an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computing and control capabilities. The memory of the computer device includes a non-volatile (or non-transitory) storage medium and an internal memory. The non-volatile storage medium has an operating system and computer-readable instructions stored therein. The internal memory provides an environment for running of the operating system and the computer-readable instructions in the non-volatile storage medium. The input/output interface of the computer device is configured to exchange information between the processor and an external device. The communication interface of the computer device is configured to communicate with an external terminal in a wired or a wireless manner, and the wireless manner can be implemented by using WIFI, a mobile cellular network, an NFC (near field communication), or other technologies. The computer-readable instructions, when executed by the processor, implement the interaction method based on a voice message. The display unit of the computer device is configured to form a visually visible picture, and may be a display screen, a projection apparatus, or a virtual reality imaging apparatus. The display screen may be a liquid crystal display screen or an electronic ink display screen. The input apparatus of the computer device may be a touch layer covering the display screen, or may be a key, a trackball, or a touch pad disposed on a housing of the computer device, or may be an external keyboard, a touch pad, a mouse, or the like.

A person skilled in the art may understand that, the structure shown in FIG. 34 is only a block diagram of a part of a structure related to a solution of this disclosure and does not limit the computer device to which the solution of this disclosure is applied. Specifically, the computer device may include more or fewer components than those in the drawings, or some components are combined, or a different component deployment is used.

In an aspect, a computer device is provided, including a memory and a processor, the memory having computer-readable instructions stored therein, the processor, when executing the computer-readable instructions, implementing the steps in the foregoing method aspects.

In an aspect, a computer-readable storage medium is provided, having computer-readable instructions stored therein, the computer-readable instructions, when executed by a processor, implementing the steps in the foregoing method aspects.

In an aspect, a computer program product is provided, having computer-readable instructions stored therein, the computer-readable instructions, when executed by a processor, implementing the steps in the foregoing method aspects.

A person of ordinary skill in the art may understand that all or some of the procedures of the methods of the foregoing aspects may be implemented by computer-readable instructions instructing relevant hardware. The computer-readable instructions may be stored in a non-volatile computer-readable storage medium. When the computer-readable instructions are executed, the procedures of the aspects of the foregoing methods may be included. Any reference to a memory, a database, or another medium used in the aspects provided in this disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache. For the purpose of description instead of limitation, the RAM is available in a plurality of forms, such as a static random access memory (SRAM) or a dynamic random access memory (DRAM). The database involved in the aspects provided in this disclosure may include at least one of a relational database and a non-relational database. The non-relational database may include a blockchain-based distributed database, but is not limited thereto. The processor involved in the aspects provided in this disclosure may be a general-purpose processor, a central processing unit, a graphics processing unit, a digital signal processor, a programmable logic device, a quantum computing-based data processing logic device, and are not limited thereto.

The technical features in the foregoing aspects may be randomly combined. For concise description, not all possible combinations of the technical features in the aspect are described. However, provided that combinations of the technical features do not conflict with each other, the combinations of the technical features are considered as falling within the scope recorded in this specification.

The foregoing disclosure includes some exemplary embodiments of this disclosure which are not intended to limit the scope of this disclosure. Other embodiments shall also fall within the scope of this disclosure.

What is claimed is:

1. An interaction method based on a voice message, the method comprising:
displaying a voice message icon and a corresponding identity icon of a sender of the voice message;
in response to a playback trigger event for the voice message, displaying a first tape reel at the voice message icon, displaying that a tape segment moves toward the identity icon from the first tape reel, and triggering a playback of the voice message;
in a playback process of the voice message, displaying that at least one of the first tape reel or the identity icon rotates, and a thickness of the first tape reel gradually decreases with a playback progress of the voice message, and displaying the tape segment connecting the identity icon and the first tape reel within at least part of the playback process; and
in response to a playback end event for the voice message, stopping display of the first tape reel, displaying that an end of the tape segment moves from the first tape reel toward the identity icon, and stopping display of the tape segment when the end of the tape segment reaches the identity icon.

2. The method according to claim 1, wherein the displaying the voice message icon and a corresponding identity icon comprises:
displaying the identity icon and a second tape reel in response to a voice message recording event, and triggering recording of the voice message;
in a recording process of the voice message, displaying that at least one of the second tape reel or the identity icon rotates, and a thickness of the second tape reel gradually increases with a recording progress of the voice message, and displaying a second tape segment connecting the identity icon and the second tape reel within at least part of the recording process; and
stopping display of the second tape reel in response to a voice message recording end event and displaying the voice message icon.

3. The method according to claim 2, wherein the displaying the identity icon and the second tape reel in response to the voice message recording event comprises:
in response to the voice message recording event, displaying the identity icon and a recording icon, displaying that a first end of the second tape segment is connected to the identity icon, displaying that a second end of the second tape segment moves from the identity icon toward the recording icon, and triggering the recording of the voice message; and
displaying the second tape reel at the recording icon when the second end of the second tape segment reaches the recording icon.

4. The method according to claim 2, wherein the stopping the display of the second tape reel in response to the voice message recording end event comprises:
displaying that a first end of the second tape segment moves from the identity icon toward the second tape reel in response to the voice message recording end event; and
stopping display of the second tape reel when the first end of the second tape segment reaches the second tape reel, and displaying the voice message icon.

5. The method according to claim 3, wherein in the recording process of the voice message, an outer contour of the second tape reel coincides with an outer contour of the recording icon, a part of the recording icon is displayed inside the second tape reel, and the part of the recording icon displayed inside the second tape reel gradually decreases with recording progress of the voice message.

6. The method according to claim 5, wherein
both the second tape reel and the recording icon have circular shapes, and a center of the second tape reel coincides with a center of the recording icon;
before the recording of the voice message starts, the second tape reel is covered by the recording icon and not displayed; and
when the second end of the second tape segment is connected to the recording icon, a radius of the recording icon gradually decreases with the recording progress of the voice message, and the second tape reel is displayed.

7. The method according to claim 1, wherein in the playback process of the voice message, an outer contour of the first tape reel coincides with an outer contour of the voice message icon, a part of the voice message icon is displayed inside the first tape reel, and the part of the displayed message icon gradually increases with the playback progress of the voice message.

8. The method according to claim 7, wherein
both the first tape reel and the voice message icon have circular shapes, and a center of the first tape reel coincides with a center of the voice message icon;
when the first tape reel is displayed at the voice message icon, a radius of the voice message icon gradually decreases, and a degree of decrease in the radius of the voice message icon is positively correlated with a message duration of the voice message; and
when the first tape segment is connected to the identity icon, the radius of the voice message icon gradually increases with the playback progress of the voice message.

9. The method according to claim 1, wherein
the playback trigger event comprises a adaptive speed playback event; and
the displaying the first tape reel at the voice message icon in response to the playback trigger event for the voice message comprises:
in response to the adaptive speed playback event for the voice message, displaying the first tape reel at the voice message icon, displaying that the first tape segment is connected to the first tape reel, displaying that the first tape segment moves toward the identity icon, and playing back the voice message based on an adaptive speed corresponding to the adaptive speed playback event.

10. The method according to claim 1, further comprising:
in the playback process of the voice message, displaying the first tape reel at the voice message icon in response to an adaptive speed playback event for the voice message, and playing back the voice message based on an adaptive speed corresponding to the adaptive speed playback event.

11. The method according to claim 9, wherein the playing back the voice message based on the adaptive speed corresponding to the adaptive speed playback event comprises:
calling a callback function of the adaptive speed playback event, and modifying a voice playback speed attribute through the callback function; and
playing back the voice message based on a playback speed corresponding to the modified voice playback speed attribute.

12. The method according to claim 1, wherein
the playback trigger event comprises a playback positioning event, and
the displaying the first tape reel at the voice message icon in response to the playback trigger event for the voice message comprises:
displaying the first tape reel and a current playback progress at the voice message icon in response to the playback positioning event for the voice message;
displaying, in response to a playback progress adjustment event for the voice message, a positioning playback progress indicated by the playback progress adjustment event at the voice message icon, displaying that the first tape segment is connected to the first tape reel, and displaying that the first tape segment moves toward the identity icon; and
triggering the playback of the voice message starting from the positioning playback progress of the voice message.

13. The method according to claim 1, further comprising:
in the playback process of the voice message, displaying the first tape reel and a current playback progress at the voice message icon in response to a playback positioning event for the voice message;
displaying, in response to a playback progress adjustment event for the voice message, a positioning playback progress indicated by the playback progress adjustment event at the voice message icon; and
triggering the playback of the voice message starting from the positioning playback progress of the voice message.

14. The method according to claim 12, wherein the displaying, in response to the playback progress adjustment event for the voice message, the positioning playback progress indicated by the playback progress adjustment event at the voice message icon comprises:
obtaining a progress adjustment position in response to the playback progress adjustment event for the voice message;
based on an initial position corresponding to the current playback progress, a center point position of the voice message icon, and the progress adjustment position, obtaining a movement angle of the progress adjustment position relative to the initial position;
determining the positioning playback progress indicated by the playback progress adjustment event based on the movement angle and a message duration of the voice message; and
displaying the positioning playback progress indicated by the playback progress adjustment event at the voice message icon.

15. The method according to claim 14, wherein the obtaining the progress adjustment position in response to the playback progress adjustment event for the voice message comprises:
recording a touch point movement trajectory corresponding to the playback progress adjustment event in response to the playback progress adjustment event for the voice message; and
using a last touch point in the touch point movement trajectory as the progress adjustment position in response to a progress adjustment end event for the voice message.

16. The method according to claim 14, wherein the obtaining the movement angle of the progress adjustment position relative to the initial position comprises:
obtaining a relative angle of the progress adjustment position relative to the initial position based on the initial position corresponding to the current playback progress, the center point position of the message icon, and the progress adjustment position;
comparing first coordinates of the center point position with second coordinates of the progress adjustment position to determine a quadrant in which the progress adjustment position is located, the quadrant being centered on the center point position; and
obtaining the movement angle of the progress adjustment position relative to the initial position based on the quadrant in which the progress adjustment position is located and the relative angle.

17. The method according to claim 16, wherein the obtaining the relative angle of the progress adjustment position relative to the initial position comprises:
obtaining a first distance between the initial position corresponding to the current playback progress and the center point position of the message icon, a second distance between the progress adjustment position and the center point position, and a third distance between the progress adjustment position and the initial position; and
obtaining the relative angle of the progress adjustment position relative to the initial position based on the first distance, the second distance, and the third distance.

18. The method according to claim 1, further comprising:
in response to a playback interruption event during the playback process of the voice message, displaying the identity icon and the first tape reel, wherein the thickness of the first tape reel is positively correlated with a message duration of the voice message, and triggering to stop the playback of the voice message.

19. An interaction apparatus based on a voice message, comprising:
processing circuitry configured to
display a voice message icon and a corresponding identity icon of a sender of the voice message;
in response to a playback trigger event for the voice message, display a first tape reel at the voice message icon, display that a tape segment moves toward the identity icon from the first tape reel, and trigger a playback of the voice message;
in a playback process of the voice message, display that at least one of the first tape reel or the identity icon rotates, and a thickness of the first tape reel gradually decreases with a playback progress of the voice message, and display the tape segment connecting the identity icon and the first tape reel within at least part of the playback process; and
in response to a playback end event for the voice message, stop display of the first tape reel, display that an end of the tape segment moves from the first tape reel toward the identity icon, and stop display of the tape segment when the end of the tape segment reaches the identity icon.

20. A non-transitory computer-readable storage medium storing computer-readable instructions thereon, which, when executed by processing circuitry, cause the processing circuitry to perform an interaction method based on a voice message, the method comprising:
displaying a voice message icon and a corresponding identity icon of a sender of the voice message;
in response to a playback trigger event for the voice message, displaying a first tape reel at the voice message icon, displaying that a tape segment moves toward the identity icon from the first tape reel, and triggering a playback of the voice message;
in a playback process of the voice message, displaying that at least one of the first tape reel or the identity icon rotates, and a thickness of the first tape reel gradually decreases with a playback progress of the voice message, and displaying the tape segment connecting the identity icon and the first tape reel within at least part of the playback process; and
in response to a playback end event for the voice message, stopping display of the first tape reel, displaying that an end of the tape segment moves from the first tape reel toward the identity icon, and stopping display of the tape segment when the end of the tape segment reaches the identity icon.
